(19) United States
(12) Patent Application Publication
(10) Pub. No.: US 2012/0175427 A1
(43) Pub. Date: Jul. 12, 2012

(54) Protection against natural dangers connected with huge streams mainly water, mud, locust

(76) Inventors: Boris Feldman, Thornhill (CA); Alexander Feldman, Maple (CA); Michael Feldman, Thornhill (CA)

(21) Appl. No.: 12/930,433

(22) Filed: Jan. 7, 2011

(51) Int. Cl. A01G 15/00

(52) U.S. Cl. 239/2.1; 239/14.1

(57) ABSTRACT

A method and system for protection against natural temperature-dependent dangerous phenomena connected with huge streams mainly water, mud, locust. The method allows weakening these streams and allows protecting against these dangers at least at of the first two stages of development of said phenomena: forming these masses and their moving, as far as possible. The method allows protecting ecology and increasing CO2 absorption. The system allows also transporting the electrical energy that is received from solar radiation with help of solar cells flying in stratosphere to ground-based reception stations.

### CROSS REFERENCE TO RELATED APPLICATIONS

This application is a continuation of U.S. Pat. Appl. 20100150656, Feldman B. et a1., U.S. patent application Ser. No. 12/386,847, Feldman B., U.S. patent application Ser. No. 12/590,322, Feldman B., U.S. Pat. Appl. 20070270057, Feldman B. and RU 2093638, Feldman B. (1994).

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The present invention relates to design of means for protection against natural dangers connected with huge streams, mainly water, mud, locust, much of which is temperature-depended dangers.

### BACKGROUND OF THE INVENTION

A group of dangerous phenomena associated with seasonal increases in ambient temperature, especially seasonal anomalies. These phenomena are characterized by the fact that inorganic or organic mass fills a huge area, water flows destroy buildings and crops, locust swarms eat up everything that grows.

The main causes of flooding are: a) the accumulation of large amounts of snow and a sharp warming causing them so rapid melting, that the existing drainage systems (rivers, canals, reservoirs, marshes) are not in a position to remove such large amounts of water, b) excessive overheating of the ocean surface (in the areas between 5 and 30 degrees north and south latitudes in Pacific, Atlantic and Indian Oceans) promotes hurricanes activity and their power increasing, c) monsoons, d) surged waves and tsunamis, d) showers, etc. All of these events are associated with temperature changes and increases sharply in the event of abnormal high temperature. The locust swarms also appear at certain temperature and humidity every some years, especially after a strong drought that itself is a terrible disaster.

It is possible to single out four groups of struggle methods to combat against these phenomena: 1) global methods of the struggle against “Global warming”, 2) preventing huge water flows forming directly in places of their formation, 3) a protection on the paths of huge mass distribution, including destruction of locust, 4) a protection of existing objects and constructions.

It is known a set of global and practically unreal offers, for example: Benford G. offered to create a concave thin Fresnel lens with a diameter equal to 1000 km, or Angel R. proposed to create billions of thin mirrors with a diameters equal to 200 meters and to locate they in Lagrange point L1 between Sun and Earth. Huge cost and complexity of such projects and impossibility to answer to important questions: a) that will be if the effect will appear less or, to the contrary, more desirable, c) that will be if climate of one countries to improve, and a climate of others countries will be essentially worsen?

Budyko M, Crutzen P., Israel Ju. offer to weaken sun radiation flux with the help of aerosol screen that can be created in stratosphere by means of sulphurous aerosol dispersion, for example, by jet planes. 200-300 thousand tons of sulphur can allow lowering mid-annual temperature about of 0.5-1.0° C. The aerosol clouds will drift in stratosphere and form the protective screen. Such screen can live couple of years and if necessary it can be created repeatedly. Technically the method can be realized, but two specified problems remain, as well as it is possible that this screen is possible to destroy the ozone layer. In addition, it is unrealistic to come to the agreement with all countries.

Now it is not known any realistic offer for solution of Global Warning problem.

Many offers are intended to the struggle against hurricanes. The part of them is specified in above-mentioned applications of authors. A number of offers suggest creating a cold water layer in the path of hurricane using artificial upwelling. An installation of constantly operating stations will demand huge expenses (the birthplaces of hurricanes are not known) and can lead to gradual heating of the deep layers of ocean. This heating can lead to dangerous consequences. On the other hand, any of known methods cannot provide delivery of means of upwelling to the necessary place at the proper time so that they at once could work.

Pat. Appl. U.S. 20100270389 (B. Feldman) suggests to use a plurality of frozen soap bubbles flying downwind. These short-living bubbles are capable of creating a protective screen-cloud having the bounded sized in space and having a sufficient density to weaken solar radiation flux.

For protection against water flows on the path of their moving a set of patents offer various variants of barriers (dams) which can be established in this path. The review of means for protection against flood is given in Pat. Appl. 20100150656 (Feldman). We note several patent materials that are most closely to our application. At first, it is known patents (D. Doolaege, Pat. U.S. Pat. No. 6,783,300 etc., Harry B. P., Pat. Appl. U.S. 20020110424) offering simple structures using elongated liquid-tight water-filled sleeves. Further, Feldman B. J. (Pat. RU 2093638) and the similar decisions in U.S. Pat. No. 6,726,405 (Rorheim T. O. Norvay, 1999) offers the flood protection barrier comprising two elongate flexible sleeves made from the water-proof material. These sleeves are filled with water, pulp, sand, or combinations thereof. They are connected by flexible web and located on the ground and located at the predetermined distance. The space between said sleeves is occupied by the ballast (concrete blocks, stones, ground, sand, metal structures, sandbags, water or any combination of aforesaid materials). Advantages of this decision: a) two sleeves that are in parallel to each other and removed from each other allow creating the bounded capacity for loading ballast, and b) the opportunity to use said ballast having any form and volume, including a free-flowing ballast and liquid.

A number of patents that offer folding protective barriers is known (U.S. Pat. No. 6,692,188, A. Walker et al.; U.S. Pat. No. 5,645,373, U.S. Pat. No. 6,450,733 Krill H-J et al. etc). Walker A. G., et al offer a folding design using a triangle barrier and an apron connected to said barrier by a pivot. Said barrier is formed by porous panels faced to flooding and a flexible panel. However, the arrangement of the apron interferes with use of the ballast increasing resistibility of a barrier. Pegs installation demands manual labor.

The barriers made in the form of pyramid of sleeves that are tightly pressed to each other require manual labor by their installation (the design of US FLOOD CONTROL CORP. and a number of other patents).

However, these constructions on the basis of the sleeves and on the basis of the inclined walls are not sufficiently effective because of roughness of earth's surface in the place of protective barriers. The increasing of said sleeve diameter can compensate it, but it leads to wind pressure increasing that is dangerous in the case of filling them with water or requires a large amount of material in the case of sand. These designs cannot also prevent a water leakage between said sleeves and the ground and practically cannot compensate roughness of ground.

Several projects represent to destruction locust swarm in flight. Talanov V. (RU 2159545) proposed a protective barrier in the form of a vertical heat-resistant grid mounted on vertical poles on the locust way and having a plurality openings those diameter is less than locust's size. Aircrafts have to periodically pour over this grid by fuel and set fire to this grid, creating a fire barrier. However, firstly, it is impossible to protect all growing on the ground surface; secondly, you need a huge amount of fuel, and thirdly, who knows in advance where the locust fly.

Patent RU 2289921 (Levin L) proposes to use a sucking pipe installed under the helicopter between its wheels to use this device in flight to combat locust swarms. They have to have knives for locust crumbling up and electrical device to kill said locust by electrical shock, and then for throwing the crushed locusts out in air. The effect of this variant is negligible, the possible tube diameter is too small compared with the swarm size, the airflow caused by screw will push away the locusts from the helicopter, the screw noise will outpace said helicopter and to repel the locusts (some people push away locust swarms by noise).

The example of the fourth group is Baruh's patent. U.S. Pat. No. 6,164,870 offered an inflatable dike that consists of several sections for protecting houses and roadways. Each of said sections has an upper cover and comprises handles for lifting this cover and inflatable lower bladder. That dike requires hand-help mounting and has deficient stability by increase of high water level.

These materials show that the problem of protection against temperature-dependent hazard does not yet have a solution.

### SUMMARY

The first aspect of this invention consists in creating of an advanced method that allows improving the protection against temperature-dependent natural hazards that are accompanied by huge inorganic and/or organic mass (water flood, surge wave, landslide and locust flood).

The next aspect consists in that offered method is based on struggle against dangerous deviations of temperature conditions in separate areas of our planet instead of as usual global methods of struggle against Global Warming. The corresponding components of the offered method should be applied in those regions where they are directly necessary or in neutral international waters. On the one hand it will allow excluding substantially direct counteraction and financial claims of the separate countries, and on the other hand it will allow using a high thermal capacity of water.

The following aspect consists in that the further progress of the offered method will allow mankind to resist better to dangerous natural phenomena irrespective of Global warming or Global cold snap. Besides the offered method does not require global investments, its action maybe stopped or transferred to other regions at any moment.

The following aspect consists in that the offered method provides for possibilities struggle at least at one or more main stages (in places of formations huge mass, in places of their moving and in places direct influence) depending on real possibilities and physical features of the phenomena.

The following aspect consists in controlling of solar radiation flux reaching Earth's surface in B said bounded areas by the means of a screening cloud creation over said area. Such screen can comprise a plurality of short-living frozen soap bubbles generated by special generators located on dirigibles or a plurality of unmanned aerial vehicles (UMAVs) patrolling in bounded space of Earth's (or Mars) troposphere or stratosphere. These UMAVs should include one or more electrical aerial engines and a group of solar cells that are locate on upper surface that are able to power supply said engines for twenty-four-hour flight.

The following aspect consists in possibility of essential expansion of a screening surface due to unfolding (unrolling) the thin flexible film-membranes (integrated or consisting of a set of separate tapes) and that is towed in air by said UMAVs. The surfaces of said membranes can be covered with special covering. The upper surface of said membranes can be covered with the reflecting layer for said solar radiation flux weakening.

The following aspect consists in that said membranes being towed by said UMAVs allow weakening solar radiation flux that reaches ocean surface in bounded on extent and on depth tropical ocean area and makes possible to cool surface layer that will allow to weaken hurricane danger and to dissolve CO2.

The following aspect consists in that said membrane can be covered both reflecting layer or absorbing including the broadband absorbing layer that is capable of transforming a solar power to frequency-independent electric energy. This energy can energy supply narrow-band electrical generators connected to nano-antennas that are tuned up the frequency appropriating one ranges of a transparency of atmospheric gases. Such membranes whose top surface are covered by the said broadband layer and bottom surface includes the block of said nano-antennas, being towed above an ozone layer, is capable of increasing the solar radiation flux reaching Earth's surface.

The following aspect consists in possibility using of said screen for warming area that is lain under it that allows improving conditions for growth of plants, accelerating thawing a snow, or detaining a rain.

The following aspect consists in using of said screen for changing of conditions (temperature, pressure, evaporation, progress of condensation in the clouds) of underlying areas. These possibilities are defined by different combinations of layers covering said membranes layers, possible locating thin flexible solar cells on their surface, as well as use of additional electrical accumulators or super capacitors.

The following aspect consists in delaying and/or accelerating melding of snow mass so that to stretch this process in time and to reduce peak intensity of melding water flows.

The following aspect consists in improving efficiency of the water pump stations (U.S. Pat. Appl. 20070270057) for artificial upwelling that allow to start operating immediately after falling these stations into water, and also in improving efficiency of fuel-air-explosive missiles (U.S. Pat. Appl. 20100270389) for weakening of dynamical and electrical activity of fast-rotating air masses hat allow forming the flammable mix under strong wind conditions.

The following aspect of this invention consists in destructing the growing bulge of the tsunami (surge) waves with powerful laser beam using the light hydraulic effect.

The following aspects relate to the protection against already moving inorganic mass (water, soil) and organic mass (locust) and the possibility of their destroying.

The following aspect of this invention consists in accelerating of installation of the protective barriers that that comprise 2, 3, 6, 10 and more separate water-filled sleeves and are pressed to each other. The use of external netlike stockings allows accelerating said barriers mounting and particularly to compensate ground surface roughness.

The following aspect consists in using of secondary tare(package) that can be leak-proof (bottles, canisters, plastic bags) and filled with sand and plugged with corks or welding. These means can be used as heavy elements for dam creation, and they unlike sandbags are not afraid of rat's nests, infections and insects. They can be filled automatically, can be dismantled and re-used. The plastic forms like cubic containers can be filled with these elements, or these elements can be packed with the help of wrapping in thin film. Such blocks having standardized size can be used for creating the heavy barrier (wall) in the path of flood. These blocks can be made preliminary, be stored in storehouses, easily be transported to necessary places and even are able to be mechanically mounted.

The following aspect consists in that said elongated heavy barrier (wall) is surrounded with water-proof flexible web at least on three sides (from the front, from below and from the rear). This web is an elongated strip, and said heavy wall is established on middle of said strip approximately and along it. The edges of the strip surrounding said wall are bent, they are fixed from above said wall that excludes the necessary to use closed sleeves. Such sleeve can block water infiltration, and it is not limited strictly by any preliminary certain diameter. The offered design supposes an increase of diameter of dam and/or its lengthening. It allows using the RDFW version as a heavy wall is possible. In this case it is also possible after dismantle of its skeleton to remove sand by means of waste pumps.

The following aspect consists in creating underground “ropes” to strengthen the soil, to combat against landslides and mudflows, and to strengthen the soil under the barriers. These strengthening means can use swelling mixture, non-Newtonian mix and material having negative Pascal coefficient.

The following aspect consists in using a plurality of micro device, including chemical and acoustic sensors to detect locust's activity, combined in an information network and located in places where can grow the locust, and said device are capable of sending messages about locust's danger.

The following aspect consists in using balloons filled with fuel-air explosive and capable to float in air for locust swarm destruction.

The following aspect consists in using a big dirigible having the through gradually narrowed internal channel including means for locust killing.

The following aspect consists in that it is offered a system using a plurality of said unmanned aerial vehicles (UMAVs) having said membranes that is capable of controlling of local climate, decreasing evaporation in drought-afflicted areas, exsiccate lakes, rain initiating etc. It is important, that character of offered influences cannot lead to dangerous unpredictable results, all results will be controllable and in case of danger said influences can be easily stopped.

The following aspect consists in using UMAVs having solar cells and effective accumulators (capacitors) for accumulating energy, and said UMAVs are capable of collecting and transmitting solar energy to ground based power stations.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein.

### BRIEF DESCRIPTION OF THE DRAWING

FIG. 1A shows a diagram of weakening of water flows caused by melting snow. FIGS. 1B-1D illustrate the concentration of solar radiation flux.

FIG. 2A shows a vertical tube for frozen soap bubbles generating. FIG. 2B shows a dirigible transporting soap bubble generator. FIGS. 2C-2D shows a gondola comprising soap bubble generator.

FIG. 3A and FIG. 3C are different variants of unmanned aerial vehicles (UMAVs) and screening membranes. FIG. 3B shows a cross-section AA (FIG. 3A). FIGS. 3D-3H represent screening membrane and its elements. FIGS. 3I-3L—represent another group of different embodiments of UMAVs. FIG. 3M shows a set of a group of said UMVAs in-flight.

FIGS. 4A- 4B represent a possibility of increasing of solar radiation flux that reaches Earth's surface. FIG. 4A represents a real view of solar energy spectral distribution. FIG. 4B shows a structure of the solar energy transformation.

FIGS. 5A-5B represent a sectional view of FAE (fuel-air explosive) missile. FIG. 5C illustrates two steps of tornado structure destruction.

FIGS. 6A-6B show a structure of a water pump station. FIG. 6C represents a scheme of said possible arrangement of said stations in the hurricane path.

FIG. 7A shows a sensor system. FIG. 7B shows a sectional view of FAE wave concentrator. FIGS. 7C-7D illustrate a light-hydrodynamic effect on surge or tsunami wave.

FIGS. 8A-8B show two schemes of oil well grouting off using a methane hydrate plug. FIG. 8C represents a diagram of methane hydrate. FIGS. 8D-8E illustrates a possible placement of shock wave generators for oil well breakdown. FIG. 8F shows a top view of said shock wave generators placement around oil well. FIGS. 8G-8H represent sectional views of generators.

FIGS. 9A-9E show the types of heavy ballast placed between two sleeves filled with water. FIG. 9F shows a stocking covering two sleeves space apart. FIG. 9G shows the barrier of US Flood Control Corp. FIGS. 9H-9J illustrate the use of stocking allowing accelerating a barrier mounting for barrier using three and more sleeves. FIG. 9K shows the barrier of WIPP Corp. FIG. 9L illustrates the use of stocking for barrier using two close placed sleeves.

FIGS. 10A-10C illustrate the loading of ballast for the barrier comprising two space apart sleeves. FIG. 10D shows a scheme of pumping wet sand or pulp for filling said sleeve. FIG. 10E shows a scheme of pumping wet sand or pulp for filling space located between two sleeves.

FIGS. 11A-11D show different elements filled with sand. FIG. 11E illustrates the automatic unit to fill containers with wet sand. FIGS. 11F-11K show blocks jointing a set of elements. FIG. 11L shows a method of connecting of two sections.

FIGS. 12A-12G illustrate possible configurations combining said basic elements (plastic bottles, bags and tubes) for the block production.

FIGS. 13A-13E show different designs of wedge-shaped blocks for protective barriers. FIGS. 13F-13I illustrate different variants of sections. FIG. 13J shows the relative position of the web and the straight members of the skeleton. FIG. 13K shows a structure of said skeleton FIG. 13L represents a shape of an envelope.

FIG. 14A represents a wall as a base of protective barrier. FIGS. 14B-14G show different cross-sectional views of the wall. FIGS. 14H-14K illustrate a process of wrapping said wall by flexible water-tight envelope. FIGS. 14L-14M show different ways of infiltration weakening. FIGS. 14N-14P illustrate the connection of envelope edges in wrapping. FIGS. 14Q-14T illustrate variants of the ground roughness compensation.

FIG. 15A shows the placement of wall sections in the case of the ground roughness. FIG. 15B shows another variant of the ground roughness compensation using inflatable balloons. FIGS. 15C-15E represent vertical pins downwards as fixing means.

FIGS. 16A-16B represents the variant using the automatic lifting of the front edge of the envelope. FIGS. 16C-16E illustrate one of possible methods allowing connecting adjacent sections of the wall.

FIGS. 17A-17B show several designs allowing mechanical fixing different anchored block. FIGS. 17C-17E show the mechanical fixing on the base of swelling mixture. FIGS. 17F-17H show the mechanical fixing on the base of Non-Newtonian mix. FIGS. 17I-17J show the mechanical fixing on the base of material having negative Pascal coefficient.

FIG. 18A represents a system to protect against temperature-depended dangerous phenomena (mainly locust). FIGS. 18B-18C illustrate process of struggle against a swarm. FIGS. 18D-18G show a design of extendable FAE container. FIGS. 18H-18I show a dirigible-cachalot for absorption of locust. FIGS. 18J-18K illustrate consecutive steps of filling and parachuting of bags filled with killed locust.

FIGS. 19A shows a reflecting membrane. FIG. 19B shows the membrane that comprises the lower layer absorbing thermal energy and upper antennas that radiate this energy in space. FIG. 19C shows the membrane that has a reflecting lower layer. FIGS. 19C-19E represent said membrane that allows creating artificial local “greenhouse” zone. These variants (FIGS. 19C-19E) are necessary not only for “Global cooling”, but also at sudden or abnormal frosts which very often cover North America and Europe. FIGS. 19D-19E are recurrence of FIG. 4B. FIG. 19D is intended for daylight hours. The upper layer 1903 (or corresponding semiconductor layer 1903) comprises a plurality of wideband sun radiation receivers. They receive sun radiation energy; transform it into direct current source that provides the high frequency generator and nano-antennas 1905 FIG. 19E is improved FIG. 19D embodiment, in which the lower surface of said film 1901 is covered by reflecting layer 1906 for reflection of Earth's radiation and can be used for nighttime. The accumulator 1910 (FIGS. 19D-19E and further FIG. 19H and FIG. 19I) shows (conditionally) that processes of absorption of heat (by one of layers 1903 and 1913) maybe separated spatially and on time from its radiation (1905) by means of the energy accumulator 1910. FIGS. 19F-19G illustrates different combinations of layers that the membranes can be covered.

FIGS. 20A-20O illustrate different variants of useful using of said screen. FIGS. 20A-20B show that the screening of sea surface allows conserving water in lakes (Aral Sea). FIG. 20C shows that the screening of ocean surface allows limiting its dangerous heating. FIG. 20D shows that the artificial cloud is capable of helping a preservation of the glacier. FIG. 20E illustrates a possibility of rain initiation. FIGS. 20E-20G illustrate a possibility to control monsoon rains. FIG. 20H shows a possibility of strengthening of wind and, accordingly, an efficiency of wind generators.

FIGS. 20I-20J (in additional to FIGS. 20A-20B) show that said artificial cloud cools a lake surface preventing water evaporation. FIG. 20K shows the protection of dry forest 2040, wherein the forest fire is possible. FIG. 20L illustrates a possibility of moving clouds, changing a solar radiation flux and creating a temperature difference in adjacent areas. FIG. 20M illustrates that the artificial cloud is capable of reducing the amount of solar energy reaching the ocean surface and increasing CO2 absorption. FIG. 20N shows a possibility of the use of morning breeze to control the flow of moist air. FIG. 20O shows that cooling of the edge of the ice field 2050 allows to strengthen this edge and to make easier navigation.

FIGS. 21A-21C illustrate a possibility of energy exchange by means of unmanned aerial vehicles-transporters. FIG. 21A represents the thin membrane, the upper layer of which is covered with solar cells. FIG. 21B represents an UMAV-energy-transporter and a transport UMAV module that is capable of accumulating energy. FIG. 21C shows possible paths of said energy-transporter and transport module moving.

### DETAILED DESCRIPTION OF INVENTION

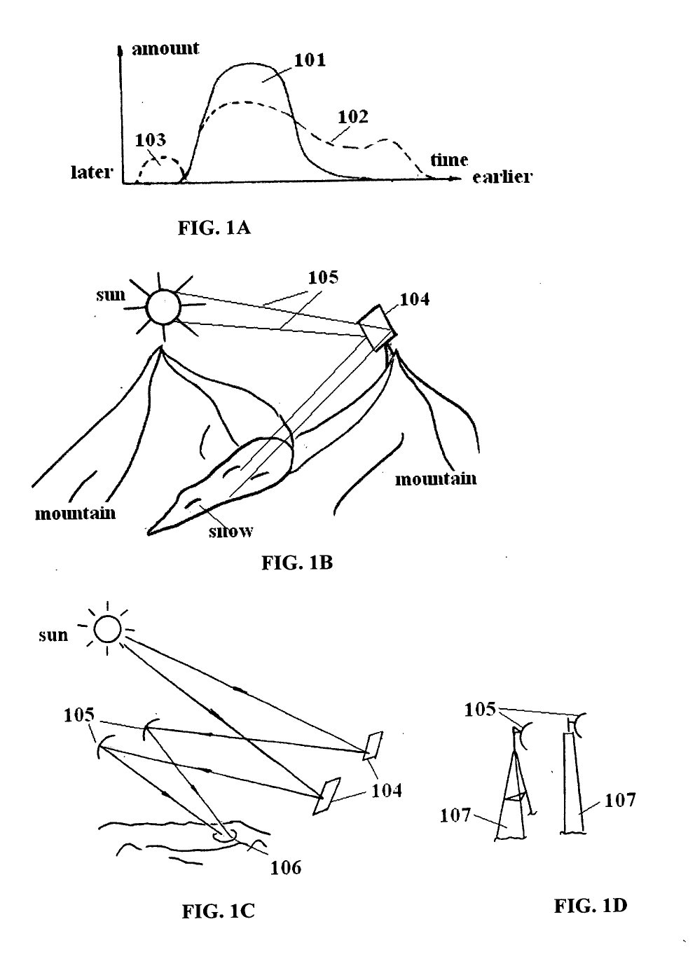

FIG. 1A represents a diagram of snow melting depending on time. The curve 101 shows an amount of melted snow at usual conditions. The curve 102 shows an accelerated snowmelt, for example, if heating is used. The curve 103 shows delayed melting by use of snow compacting, freezing etc. The maximum intensity of a water stream (a maximum of a dotted curve 102) decreases as a result of these actions, and drainage systems can cope with melting water flows. FIG. 1B shows one of possible variant of heating using solar heat. The sun rays 105 fall on the mirror 104 that is placed on mountain and reflects (or concentrates) these rays on snow masses. FIG. 1C represents another variant of similar system. The sun rays reflect from mirrors 104 to the concentrators 105 and reach snow mass 106. Said mirrors 105 can be placed on the artificial towers 107 (FIG. 1D) or on flying apparatus. A rotation of said mirrors can increase the time period of effective operating.

The delayed snow melting can be caused by the shock waves created by low-flying jet aircrafts that break through the sound barrier (not shown) and can compact snow masses. It can be used air-dropping dry ice or placement of hygroscopic gel. This allows weakening the flows of melting water. The delayed melting of snow allows the existing drainage systems, canals, rivers and sewage to cope better with the flows of melting water.

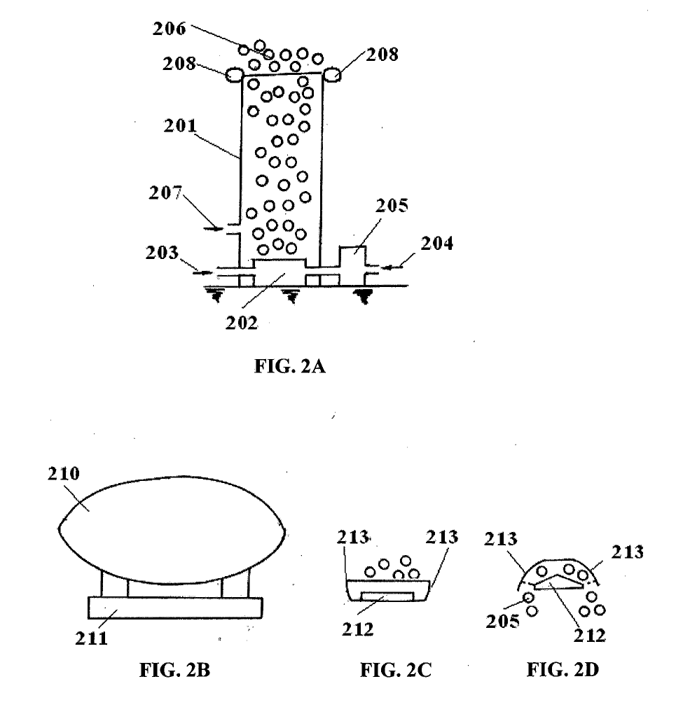

FIG. 2A-2D represent passive means in the form of frozen soap bubbles for screen located over Earth's surface creation. The frozen soap bubbles have sufficient strength to exist in air and to move together with wind during several hours or days. These soap bubbles are simply a very thin sheet of water sandwiched between two layers of soap molecules (also called surfactant molecules). Said “short-living” property gives confidence that such screen or at least its considerable part (density) will not get on forbidden territory. A possibility of a covering of a considerable part of the earth's surface (in particular, the international waters of ocean) allows not only to use these frozen soap bubbles as the local screen, but also to be competitive means for struggle against global warming. Really, according to P. Krutsen's and Ju. Izrael's analyses the weight of solid micro particles that are necessary for the screen creation is equal to 0.2-1.0 mill. tons. J. Izrael considers that the most effective particles have to have the size (diameter) of 0.5 microns. Let us suppose, for simplicity, that these particles have the spherical form, the density—2 tons/cu.m, the weight—0.5 mill. tons (NB! —this value is two orders less than that weight that has allowed volcano Pinatubo to reduce decrease total temperature by 0.5° C.). Let us agree to use the following symbolism: M—the weight necessary for screen creation, tₛ—the thickness of a bubble film, ρ—the density, dₚ—the particle diameter, index “ₛ”—soap, index “ₚ”—particle, b˜0.25-0.35 ( [symbol] [symbol] [symbol] [symbol] [symbol] ). In our case: tₛ/dₚ˜0.1, ρₛ/ρₚ˜0.5, approximately.

Then the amount of these particles (N) is equal to:

N=0.5*10⁶ tons/2(t/cu.m)*(pi/6)*(0.5*10⁽⁻⁶⁾m)³=˜4*10²⁴

The square of a reflecting surface is N*0.5*pi*(0.5*10(⁻6)m)2=1.6*10¹² qu. m. And the weight of said particles that is necessary for the similar screen creation is equal to:

Mₛ˜α*Mₚ*b*6*(tₛ/dₚ)*(ρₛ/ρₚ)˜0.075*α*Mₚ,

a≦3 shows the effect of diameter decreasing (not comparing their lifetimes). Therefore, the use of said frozen soap bubbles allows creating the screen that does not concede to the screen that consists from “particles”.

Said frozen soap bubbles can be generate with the help of ground-base factories (FIG. 2A) or in-flight (FIG. 2B) using dirigibles (or aircrafts, or hybrids). The vertical tube 201 of said factory can be made from a heat insulation material, can comprise a soap bubbles generator 202 using, for example, a soap bubble fountain design or a soap bubble rotating wheel design. The inlet 204 is connected to water source; the unit 205 is a solution source. The inlet 203 is connected to the light gas (or mix of air and gas-He, H2, CH4). The term “light gas” or “light-weight gas” designates the gas or the mix that isn't heavier than air at predetermined height. A refrigerator (not shown) supplies the interior of the tube 201 with cold air (between −7° C. and −20° C.) via the inlet 207. It is possible a design that said vertical tube is fastened to a dirigible (it is not shown) or a balloon 208 filled with light gas. The dirigible 210 (FIG. 2B) comprises an elongated gondola 211. This gondola includes a soap bubbles rotation multi-nozzles generator (not shown). Besides, said bubble generator can include a snowflake generator which promote easier and fast freezing. In flights at the heights of 3500 meters and more the air temperature is equal to −7° C. and below (−24° C. at the height of 6000 meters, −50° C. at the height of 10000 meters, approximately, and etc.). Such height of the flight provides the necessary temperature for said frozen soap bubbles creation. Said dirigible has to transport necessary water and solution with itself. A set of dirigibles should take part in of formation of this screen moving with a speed concerning air which does not exceed the predetermined value. FIG. 2C and FIG. 2D show the walls 213 protecting a place where said frozen soap bubbles 205 are formed by a generator 212. The cloud consisting of white frozen soap bubbles creates a screen well reflecting sun beams.

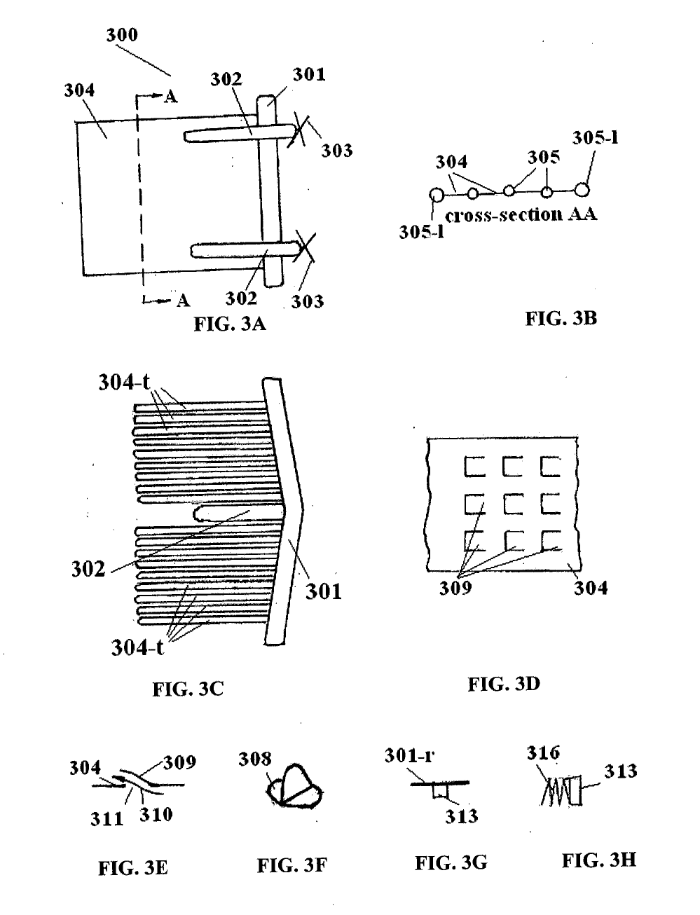

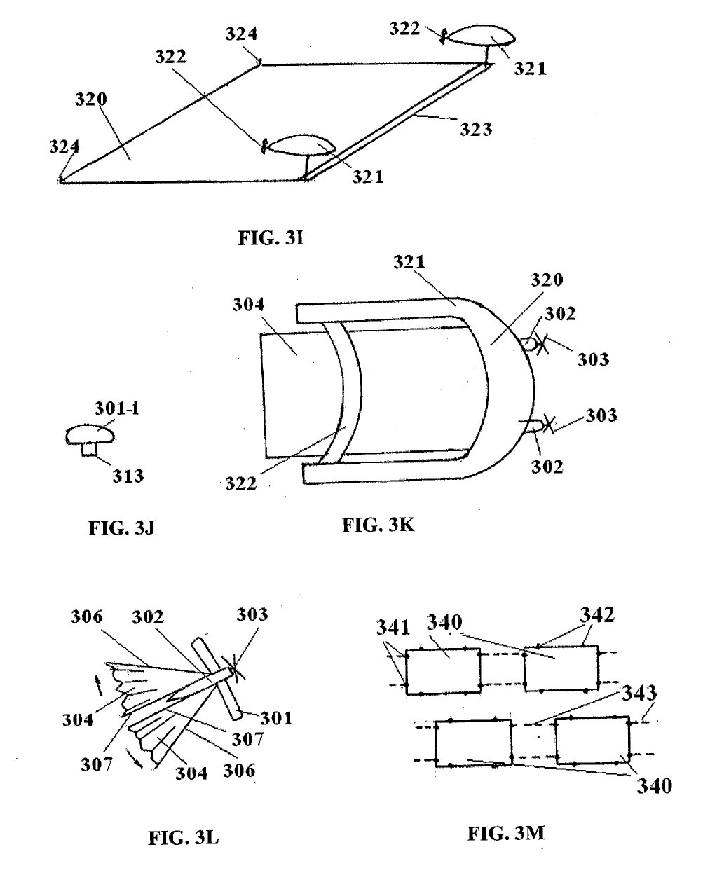

Unmanned aerial vehicles (UMAVs) are most real active means for screen creation. FIG. 3A represents such UMAV 300. It has wing 301, fuselages together with engines 302 (one or more), airscrew (screw or propeller) 303 (one or more) and thin film flexible membrane 304. This membrane can have stiffening ribs 305 (FIG. 3B), can use lateral placed tubes 305-1. The membrane 304 can be made of metalized (non-transparent) polyimide having approximately 0.004-0.0045 mm of thickness and can be made as an integral (unbroken) film, or it may be divided to a set of separate thin strips. The upper surface of this membrane can be covered with reflecting, or absorbing and transforming thin layer, it can include flexible thin solar cells. FIG. 3C shows said membrane consisting of a plurality separated strips 304-t, each of which is covered, for example, with thin reflecting layer (it is shown only a fragment of fuselage 302 and wings 304). These strips allow considerably reducing the aerodynamic resistance and, above all, the danger caused by the strong gusts of wind. At the end of each strip an element of aerodynamic stabilization can be located. This element is intended for stretching corresponding strips using little additional aerodynamic resistance. FIG. 3D illustrates a plurality of petals 309 that are formed on the membrane 304 and that allow sharply to reduce aerodynamically resistance, but to retain the capability of reflecting. FIG. 3E illustrates other possibility of stabilization of position of a membrane 304. Apertures 311 and rejecting petals 309 allow counter airflow 310 to extend said membrane. Such membrane (or these strips) has one or more stabilizing element 308 on the remote end like this is shown in FIG. 3F. This element can have its cylindrical form with longitudinal hole (not shown). The strips can be mounted with an overlap. The devices for rolling (folding) and unrolling (unfolding) can be mounted in said UMVAs. These strips can be rolled during taking-off and can be unrolled after it using, for example, the holding ropes that can be broken (blown). The taking-off and the landing of said UMAVs are possible independently on these strips. The shape of said membrane can be different. From below said wing 301-r (rigid) is fastened a membrane roll (fold) storage block (further: traverse block) 313 (FIG. 3G) that includes means for folding (rolling) and unfolding (unrolling) said membrane 316 (FIG. 3H). The upper surface of this membrane can be covered flexible thin solar cells. Said unfolding (unrolling) can be carried with air pressure exerted with a built-in pump (not shown). Special electromotors (not shown) or resilient elements can to fold or to roll said membrane. It is possible that rolling and/or unrolling are unnecessary. The UMAVs can fly up and land even having unrolling thin strips. The devices for rolling (folding) and unrolling (unfolding) can also be absent to reduce the cost. FIG. 3I shows other embodiment of UMAVs on the base of double-bodies dirigible comprising two fuselages 321, each of which has an electrical engine 322, the traverse 323 for membrane storage. The membrane 320 comprises stabilizing and/or supporting (for example, light gas filled balloons) elements 324.

The speed of UMAVs should be sufficient only that said UMAVs that are patrolled in the given limited area could return, changing if necessary the echelon (on height and area) so that to not appear on airways and over forbidden territory, or even to carry out landing before border. Said UMAVs can fold (roll) their membranes before landing. The limited speed, the minimal equipment and the maximal simplicity of mass UMAV design allow the use also of other execution using more simple inflatable designs. Such UMAVs should include: 1) the minimal equipment (the engine screw or compressor), the accumulator, simple management), 2) solar cells, 3) the minimal devices (receiver GPS and the meteorological receiver), 4) devices for information interchange about approaching of adjacent UMAVs. FIG. 3J shows a variant, in which an inflatable wing (301-i) is fastened from above said traverse for membrane 313. FIG. 3K represents a hybrid version on the basis of inflatable wings 320 (similar to “a triangular wing”) and additional sleeves 321 protecting against collisions (though partially). The inflatable design simplifies a problem of collisions-they cease to be accident. These sleeves can be in addition connected by the crosspiece 322. Wings are filled with easy gas (air or gas mix that is not heavier that atmospheric air at given height) and can include separate the section filled with air. Heating of such section allows maneuvering on height. The traverse is located under a wing 320 it (is not shown). For such membranes the moving speed is not very important. The UMVA can even fly with wind, then to roll its membrane, further to return on an initial position and again to fly with wind. The greater area of a membrane forces to look for areas or the time periods then wind conditions are quieter. Said UMAVs have to comprise means for rolling (folding) and unrolling (unfolding) their membranes. A little electrical controlled pump (s) can unrolling (unfolding) said membrane pumping with air or light gas to built-in tubes. It can be used also artificial electrical controlled muscles. Little electromotor(s) can roll (fold) said membrane. The rolling (folding) said membrane are carried out in the cases: landing, sharply changing altitude, ending operating time, leaving predetermined area etc. FIG. 3L shows another embodiment of UMAV comprising sliding membranes 304 that are capable of turning by guides 306 and 307 similar to a fan. It is known that the modern solar cells are able to provide very long flight UMAV. Such UMAV can be different form, for example, a “flying saucer” (not shown), round which is fastened a thin membrane. The special pumps (not shown) are power supplied from solar cells. Said light gas (air) passes inside a ring pipe through radial pipes . The ring pipe stretches the thin web. Different type of UMAV can be applied, for example, “flying wheel” or “flying wing” (not shown). Slow flying apparatuses having inflated lateral surfaces allow said UMAVs are much less afraid of collisions. Such flying apparatuses can use as said airscrew engines, so and pneumatic engines.

FIG. 3M illustrates some streams 343 consisting of UMAVs with the unfolded webs 340. Along the edges of said webs light or sound elements and sensors 341 and 342 are located. They allow informing said UMAVs about neighbors approaching and to reduce danger of collisions of these UMAVs, whose route can be defined with GPS. These UMAVs also can have similar elements located from above and from below them that are useful at creation of a “cloud” using height separation. UMAVs can form such cloud-screen, flying by layers on different high-altitude echelons. It is known software for control system (SMAVNET) that has been developed on the algorithms based on behavior of insects swarms like ants and bees.

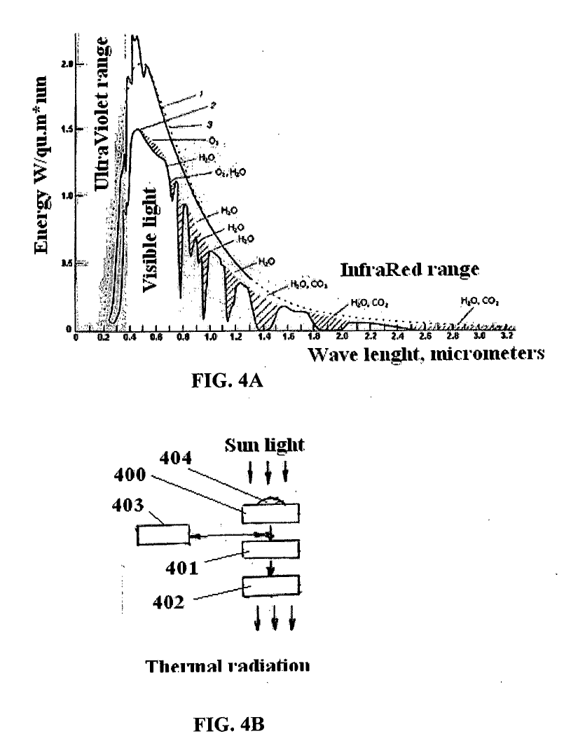

FIG. 4A gives the approximate view of the dependence of the transparency of the atmosphere from the frequency of solar radiation (this dependence can change depending upon a point of the time, a season, and a sun activity). Such dependence shows that part of the energy (UV) is absorbed by atmospheric ozone level; other part of solar energy is absorbed by water vapor and CO2. A creation of clouds UMAV flying above the maximum of the ozone layer allows absorbers-receivers (wideband solar cells or thermal units) to absorb all incident energy, and then using infrared (IR) generators to radiate this energy in one of the ranges of transparency. This variant allows increasing in the amount of heat energy reaching the earth.

FIG. 4B shows possible block-circuit of this transformation. 400—wideband solar radiation receiver, which converts the energy of radiation to frequency-independent form, such as, for example, direct current power (DC), 401—GHz-generator corresponding to chosen IR range. It is known that depositing thin film of silicon nanoparticles (one billionth of a meter in diameter) on silicon substrates allowed creating a photo cells sensitive to UV light (Inv. of Illinois) and can be a base for creating wideband solar cells. Multilayer solar cells of a concentrator type are capable to convert UV, visible and IR to electricity. They already now have efficiency up to 40% approximately, and the theoretical limit 87%. The wideband radiation receiver can be made as photo-electrical solar cell or thermo-electrical converter, or a block of multilayer nano-antennas. The last variant is more complicated, and it requires very complicated 100-200 THz diodes that are intended for transforming to DC. Now 100 THz diodes are only in a research position (as and multilayer nano-antennas). The high-frequency antennas block 402 are located under bottom of said UFMA and are capable to radiate in the ground surface direction. S. Novack et al. described similar nano-antennas made from wire having about 200 nanometers thick and imprinted on the plastic substrate for infrared range. The property of reversibility of antenna systems suggests this experiment confirms the possibility of using these arrays as radiator. The accumulators or super capacitors 403 are designed for powering during the day. The convex facet glass or lens 404 may help to concentrate sun light. Such clouds can be useful for accelerating the melting of snow and to create more comfortable conditions for crops. Even a slight (+0.5° C.) rise of average temperature can be significant such as grapes. The surface may have an undulating topography, the top bulges, which is useful by changing the sun position. Said division into layers is conditionally, various decisions are possible.

Under such conditions many of these UMAVs allow to create a cloud darkening the sunlight by constantly patrolling over certain areas of the earth (or sea) surface. It corresponds to modern tendency of “smart dust”. Similar UMAV during takeoff may have folded (or rolled) membrane, which can be unfolded (or unrolled) like the Sun Sail during to flight. These membranes can be folded (rolled) by strong wind. Instead of said UMAVs can be used modified insects, or plastic capsule (original small “flying saucers” or micro-airships, on the upper surface of which are placed solar cells). Changing a shape of such “saucers” allows controlling movement in the air (pushing and sucking air in the required direction-not shown). The cloud of such “smart dust” can form as an “umbrella” that can decrease the heating of earth surface. Said UMAV should fly on some distance from each other, and for screen density increase said “cloud” can be altitude separation, i.e. should be created a set of screen “layers”, corresponding to different height echelons.

Said UMAV may include a chip for connection with the ground stations and /or GPS (not shown). It is necessary to allow said UMAV maintain given required flight level of height (echelon), avoiding the aircraft routes and very strong opposite wind. Said UMAV may include means for short distance communication. It can be radio or HF electromagnetic oscillations, warning light or sound warning. Different colored warning lights can to inform neighbors, from what party the device comes nearer, and different sound tones or accords specify, from what party and as far there is a neighbor. Strong absorption of a sound and ultrasound in air allows use calibrated source amplitude for estimating a distance to the neighbor. It can be helped by the extendable membrane and directed reflectors and/or sounding bafflers. However, the high level of atmospheric electromagnetic noise, apparently, makes the latter preferable. Using ultrasound (creaking, grinding) can be avoided (or at least reduce the risk of) loss UMAV because of mutual collisions. Increased level of received sound in the interval between pulses shows that the number UMAV around growing and need to move in the opposite direction. Such opportunities can reduce the number of collisions UMAV.

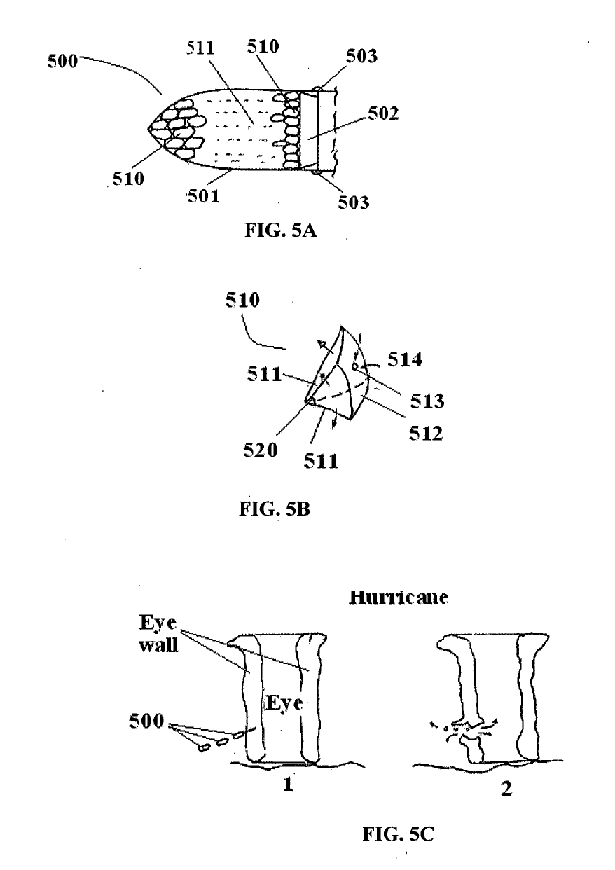

Further a set of method of combat against forming huge water masses. Pat. Appl. 20020088364 (Feldman B.) offered to use for hurricane (tornado) weakening by means of a plurality of the fuel-air-explosive (FAE) missiles 500 (FIG. 5A) that can disrupt the structure of the rotating air mass and sharply reduce the electrical activity that plays a significant role in the progress and maintenance of hurricane. It is necessary to form a mix having a concentration that need for an explosion inside a set of separate containers covered and to protect this mix against wind. The missile 500 has a housing 501 that is filled with a plurality of said containers 510 in folded state. Said housing 501 includes a sensor 503 and a booster 502 connected to said sensor 503 and intended for breaking this housing 501. Said container is filled with FAE. Each of said containers (FIG. 5B) includes also a sensor (or timer) connected to FAE detonator 520. Said sensor allows waiting for predetermined flammable concentration, and said detonator allows exploding this mixture. Each of said containers has walls 511, 512 made from light combustible material (other walls isn't named). At least one of said walls includes an opening 513. Said walls includes embedded expanding means, for example, shape memory alloy, resilient plastic, whalebone, or inflatable tubes that are capable to expand said container and to suck air 514 inside through said opening 513. At the same time inside said containers the concentration increases, and when it reaches to inflammable concentration, then it explodes according to an external signal of said timer or said sensor of concentration. FIG. 5C shows an expected result of said missile actions. The supersonic jet airplanes must launch a set of said missiles 500. The first step: the flow 500 of said rocket penetrates into hurricane wall (1), the second step (2): these missiles break vertical structure, help to create “through windows” in eye wall of hurricane using the difference between the external pressure (˜1 atm) and the internal (in eye) pressure (˜0.9 atm) and weaken an electric field in a cloudy part of hurricane. These attacks can essentially to weaken the hurricane. It is the formation of explosive mixture to the inflammable concentration level inside sheltered interiors of said containers having easily ruptured (by explosive) envelope allows effective to use of said missiles with FAE.

If the weakening of the tornado is over a solid surface of the Earth, where there may be people and structures, the area of impact shall be at least at a height of 100 meters or more above the ground. Then the weakening of the hurricane is over sea, no such restriction. Shock may be caused at any level above the ocean surface, to promote weakening the recharge energy from the water.

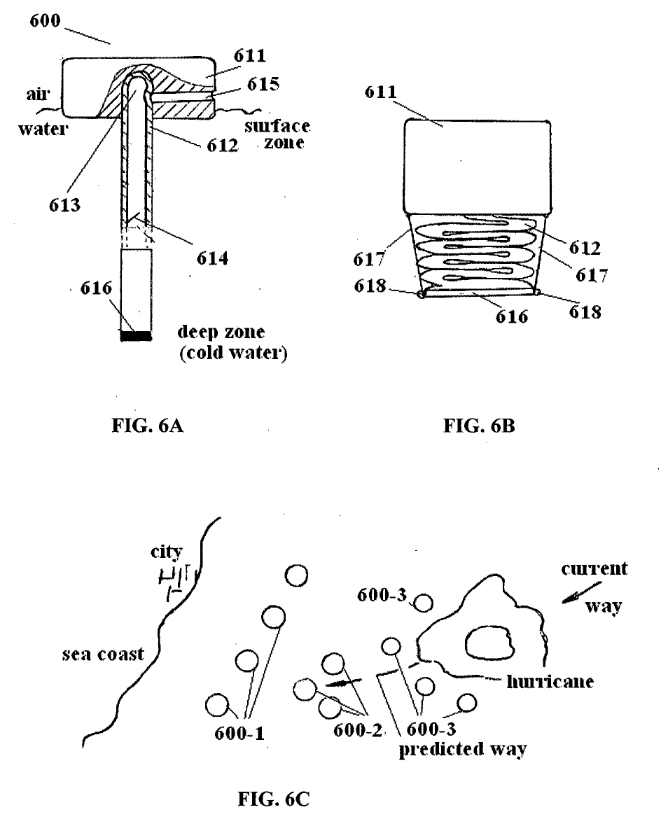

The water-pump stations (FIG. 6A, U.S. Pat. Appl. 20070270057, B. Feldman et al.) or wave-driven devices 600 can be used for artificial upwelling (deep cold water lifting) and cooling ocean surface. These station can be airdropped. Such water-pump station includes a floating body 611 and a long flexible conduit 612 having a valve 614. Inside this body a long internal cavity 613 connected to air by a tube 615. The conduit 612 ends by weights 616 that are symmetrically attached around lower open end of said conduit. The FIG. 6B represent said station in the folded state. The folded conduit 612 is held in this position by cords (ropes) 617. These cords are connected to boosters 618 that are capable to explode at contact to water and to break said cord and to release said conduit 612 that becomes straight. Such solution allows said station that being airdropped can immediately be suitable to start said upwelling. FIG. 6C shows one example of their application. Such stations can be installed (for example, can be airdropped) on the hurricane way (600-1, 600-2, 600-3) or in parallel to sea coast.

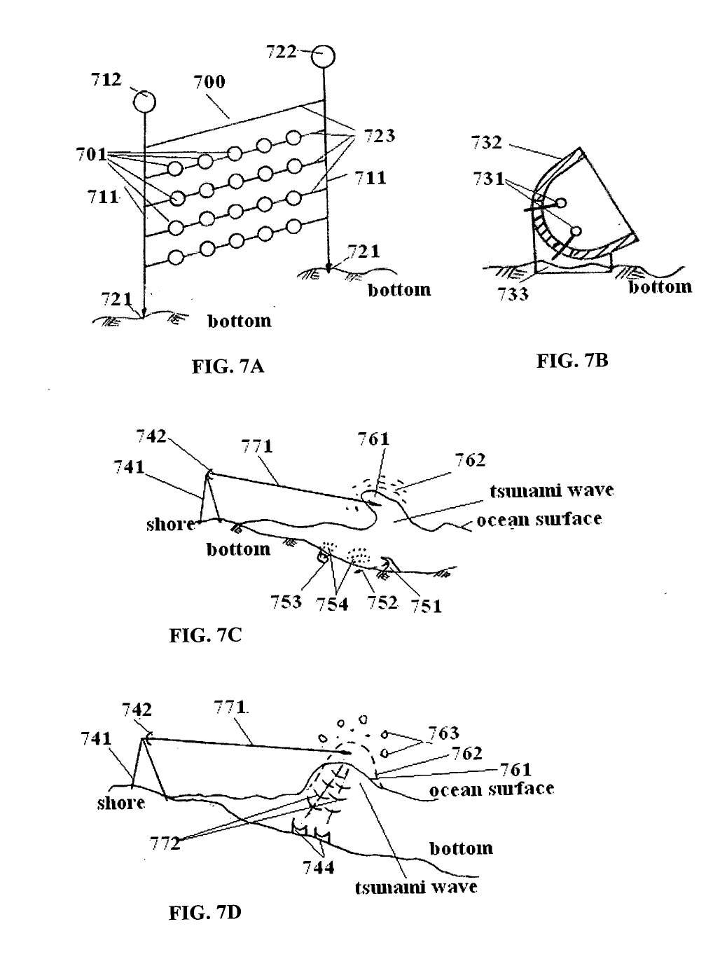

FIG. 7 represents one method for weakening surge wave and tsunami waves. FIG. 7A shows an example of a net 710 for tsunami wave detection. A plurality of sensors 701 is located on the possible way of tsunami. Said sensors 701 are fastened between two verticals 711 with the help of connections 723. Said verticals are mounted between anchors 721 and floats 722. Such nets allow beforehand to detect tsunami moving and to control following devices. It is possible to use transcontinental cables for tsunami detection. FIG. 7B shows two electrodes 731 of Yutkin's electrohydraulic shock wave generator. These electrodes 731 separated from each other by the gap. The spark jumps across said electrodes 731 and generates the powerful stock wave. These electrodes are located inside a reflector 732 that is fastened to bottom 733.

FIG. 7C illustrates the destruction of the growing crest of tsunami wave (hump) 761 by laser pulses 771 that are created by a laser 742 mounted on a rack 741. A lighthydraulic effect destroys the wave 761 spraying her in the view of 762 and forces at least a part of water mass to move from water to air and back losing energy. As said laser a ruby laser can be used. Various impurities-gas bubbles, sand, and paint particles-scatter the light and become centers of local boosting this effect. Such turbidity 754 may be created, for example, by an explosive 753 or Yutkin's electrohydraulic shock wave generator 751 (FIG. 7B). FIG. 7D shows the possibility of combined impact using two sources: shock pressure 772 created by the elektrohydraulic shock wave generators 744 (see U.S. Pat. Appl. 20100150656), pushing out a lot of water in the air 762 and said laser 742 that destroys this water hump spraying 763 and depriving it of the accumulated energy. Such systems installed in hazardous locations and associated with different warning systems reduce the danger of tsunami flooding.

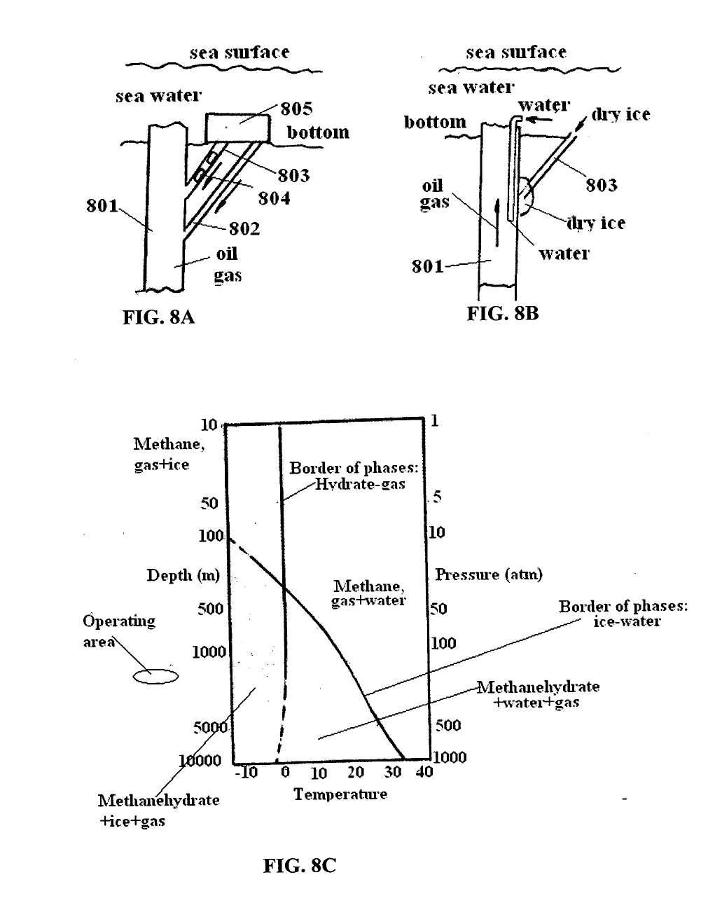

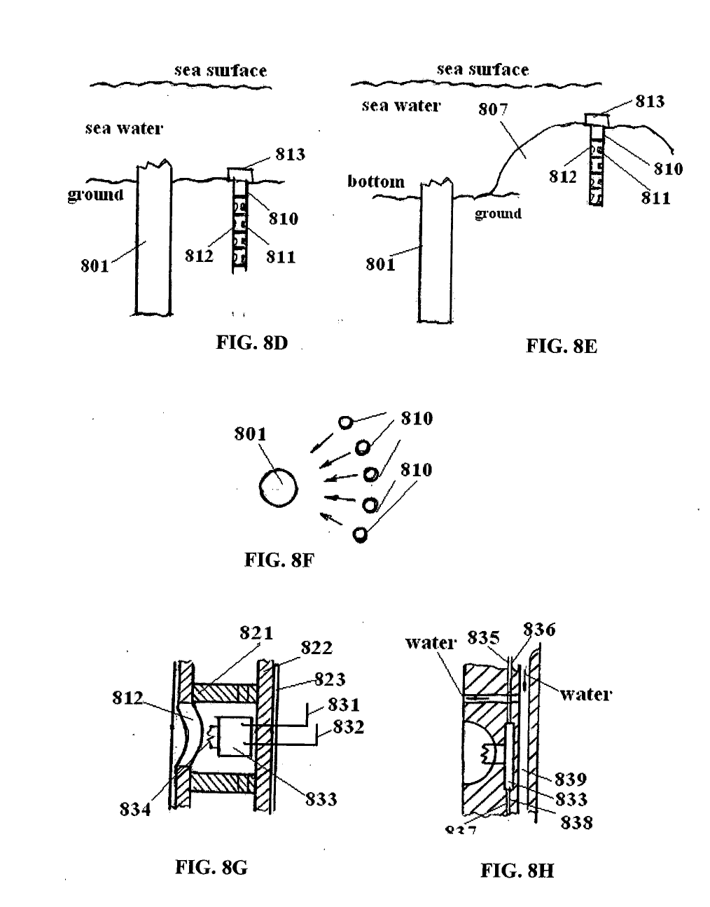

The potential danger of “a fiery tornado” or “a fiery hurricane” can arise when disturbed offshore oil platform is located on the possible ways of hurricane. Gas or oil vapor mixed with the air can be set fire by the slightest spark. The experience of the Mexican Gulf disaster shows that its elimination can last for months. FIG. 8 shows two possible ways to combat against said accident. The first method (FIG. 8A, B, C) allows to cork up the oil well by methane hydrate plug. FIG. 8C represents a diagram of methane hydrate state for pure water. Adding NaCl shifts this diagram to the left. The operating area for the depth of 1500 meters is shown. The hydrate formation requires a temperature in the range of −20° to −40° C. at this depth. FIG. 8A and 8B illustrate this method. Oil and gas flows lift inside an oil well 801. The cooling flows (a liquid N2, a liquid or solid CO2) 804 goes through the pipe 803 from the source 805 located on the seabed. Water (or its vapor) is piped by second pipe 802. As a result, over the outlet of the first pipe the methane hydrate plug arises. FIG. 8B shows another variant of the system. Naturally, such pipes have to be very well warm-insulated.

FIG. 8D-8G illustrate another offered method for said oil well destruction by way of its compression (801). Instead of the usual explosion of conventional explosives (delivery of the required quantity of which and their deepening into seabed thickness is quite complicated and expensive) or even a nuclear explosion (Russia) it is suggested to squeeze said oil hole by way of a shock pressure that is a plurality of elektrohydraulic generators (EHG) 811 placed along the pipe 810 can create through windows 812. This pipe can have a small diameter but stable walls. This pipe is lowered into ground at sufficient depth. The group of these pipes 810 can be located around the oil well 801 (FIG. 8F). Simultaneous activation of all electrohydraulic generators can move the soil and squeeze the tube 801. FIG. 8E illustrates the possibility of closing the hole of said oil well from above by shifting ground hill 807. FIG. 8G and 8H show two embodiments of the EHG's cell. The pipe 822 is sectioned by metal partitions 821 and cylinders 822. EHGs 833 are placed inside these sections. 734 is an active element (spark gap or a metal tape). Lines 831 and 832 (as well as 837 and 838, 835 and 836) are the control lines and the power lines. The concave surface of the section 824 allows for greater force of impact. The channel “water” is intended for this purpose. The possibility of multiple explosions creating is an additional advantage of this method. This methane-hydrate plug may be more useful than using cement. It allows reanimating said oil holes after the necessary works with the help of methanol.

The third last line of defense against flood is the barriers, in particular, mobile barriers, based on the use of filled sleeves and envelopes. Practically all known structures have following main problems: retention on place, terrain roughness compensation, mounting speed and a labor content.

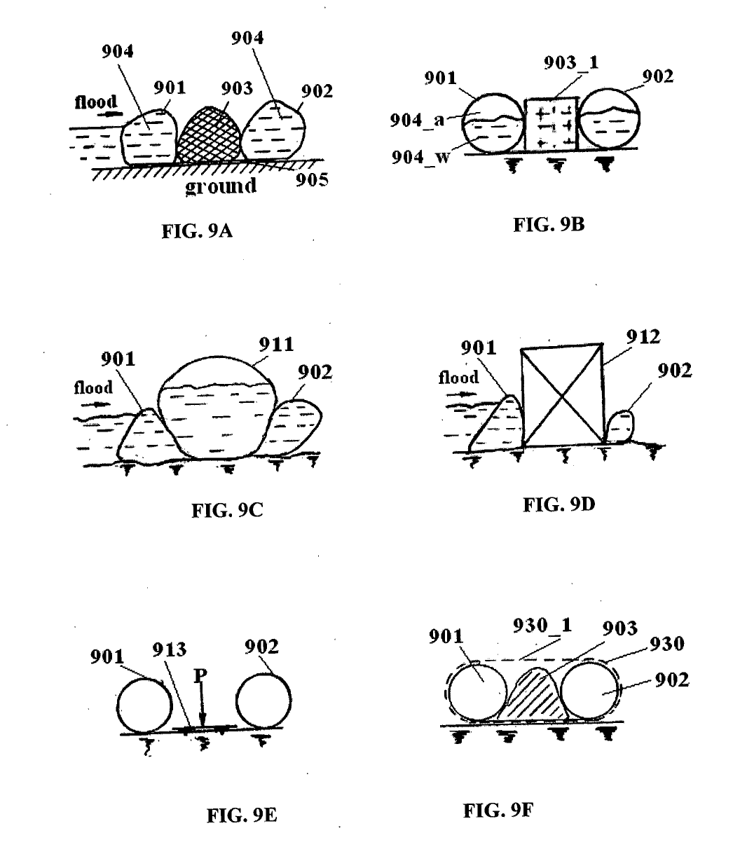

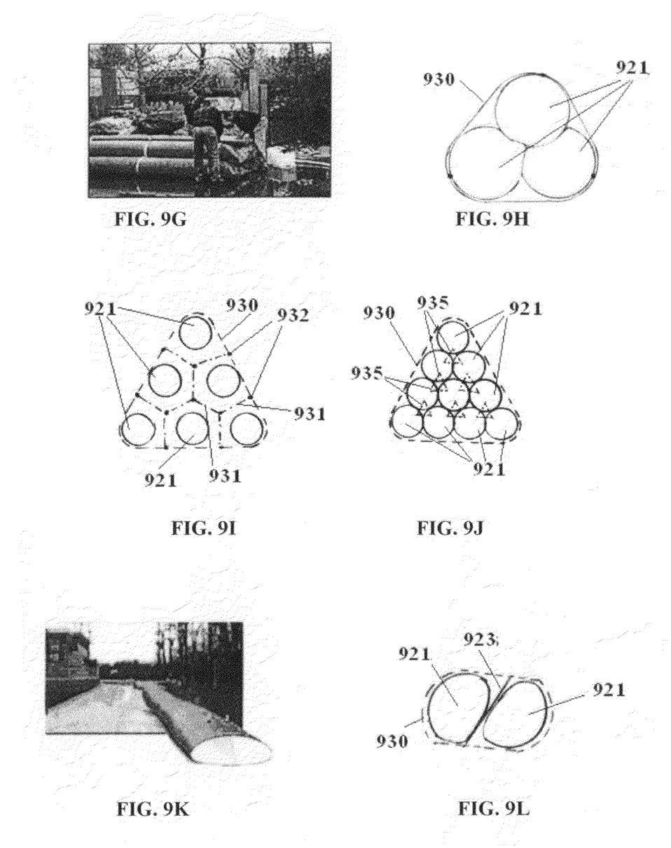

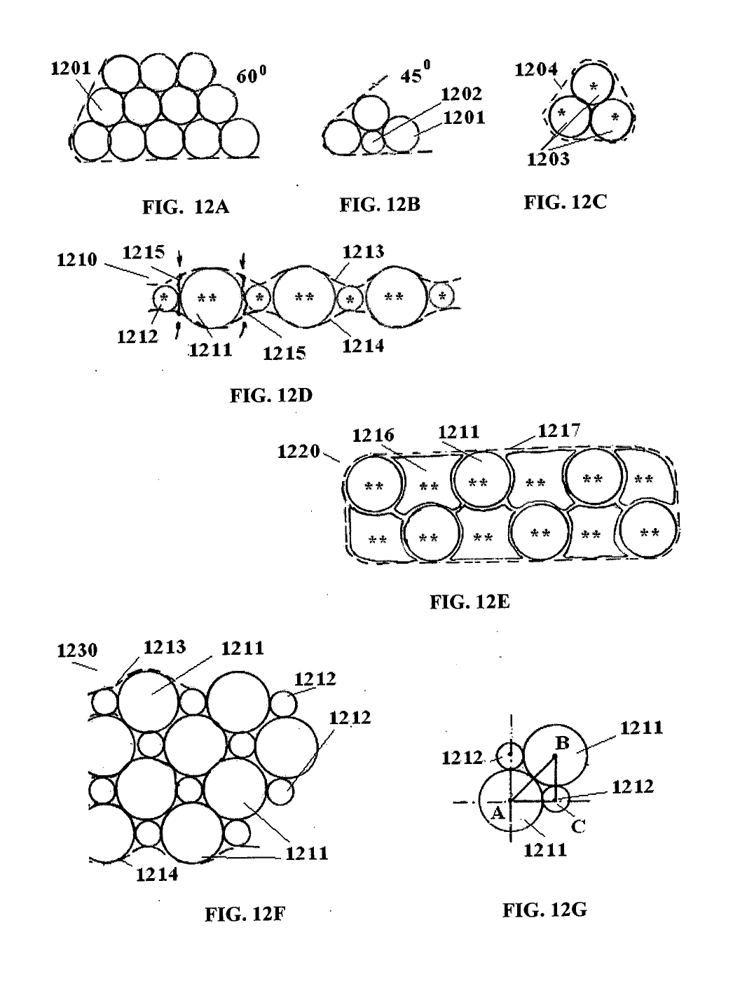

FIG. 9A, FIG. 9F, and FIG. 9J show three main constructions wherein anti-flood barriers comprise two or more parallel, spaced apart, inflatable, elongated flexible sleeves and that are described, correspondently, in RU Pat. 2093638, by US Flood Control Corp., and by WIPP. FIG. 9A shows a ballast-oriented barrier comprising two elongated sleeves 901 and 902 that are filled with water (pulp, sand) 904 connected by web 905 (according to RU Pat. 2093638). The heavy ballast (weight) 903 is placed between these sleeves on said web. FIG. 9B shows the case when a beforehand prepared heavy block 903_1 is used as said ballast. A use of such heavy blocks allows limiting by partial filling said sleeves with water that can be useful to acceleration of the dam preparation. Another part (904-a) of these sleeves can be filled with air at least temporarily. FIG. 9C shows that said ballast can be made in the form of the elongated, inflatable sleeve 911 having greater cross-section size and located between said main sleeves 901 and 902. This sleeve 911 has to touch with other two main sleeves only in points belonging to their internal surface. FIG. 9D represents a variant, in which a heavy wall 912 (see below FIGS. 12-16) located between said main sleeves is used as said ballast. Main sleeves 901 and 902 protect this barrier against water leakage from below. FIG. 9E shows that last two embodiments allow also reducing water leakage using additional means 913 (further detailed FIG. 15) and the weight of 911 or 912. FIG. 9F shows a netlike stoking 930 (or separate segments, or tapes) that envelopes said sleeves 901 and 902 moved apart by ballast 903 allow to keep the form of sleeves at pressure of ballast and to give the chance to change height tightening a stocking. The upper part of said stocking 930_1 can have cells of different sizes.

FIG. 9G (US Flood Control Corp.) represents another ballast-free barrier consisting of 3 (or 6, or 10) water-filled sleeves 921 and tightly pressed to each other. FIGS. 9H-9J show implementations, wherein said barrier is surrounded by a netlike (or continuous) stocking 922 that are tightly pressed said sleeves 921 to each other that allows to accelerate mounting such dam. This netlike stocking has to have its perimeter that is slightly less than the perimeter of cross envelope of said barrier in case of fully filled sleeves. Such stocking allows excluding human participation by said barrier mounting. FIGS. 9I and 9J show two variants of cross-section such barrier using 6 and 10 tightly pressed sleeves 921. For clearness (FIG. 9I) these sleeves that are really tightly pressed to each other conditionally are removed from each other. The stockings 930 can consist of separate individual segments (or tapes). The tapes 931 are connected in separate groups and connected 932 to an external part of said sleeve envelop so that each sleeve has appeared in a separate cell (like honeycombs). FIG. 9J shows the second variant. All sleeves 921 are divided into groups each of which includes three sleeves. Each such group is designated as small triangle and is surrounded by a plurality of corresponding enveloping stockings (segments of stocking) or tapes alternating along said sleeves, but so that they don't interfere to each other. Such barriers comprise n₀=Cₖ₊₁² said sleeves and n₃=Cₖ² said groups (threes), where: k-the number of sleeves that are placed in the bottom layer of said dam. Correspondently, n₀(n₃)=3(1), 6(3), 10(6), etc. These design FIG. 9H, 9I and 9J allow accelerating dam installation. Third WIPP's design FIG. 9K uses a sleeve divided into two parts by solid strip-plate to increase the stability. The offered design (FIG. 9L) of the ballast-free barrier offers to use two sleeves, to separate their by a set of inflexible short external plates 930 and to surround their by the stocking 923 that allows to simplify such barrier mounting and to exclude internal plate(s).

Above proposed allows to improve existing barrier structures (mobile dams) using flexible sleeves-tubes. Their advantages (portability, simplicity of their installation) are accompanied by important disadvantages, including: the limited ability to compensate for roughness of ground surface, the difficulty of using more heavy filler than water, and the difficulty of holding such barrier in place. These problems are resolved partially in mobile dam according to RU Pat. 2093638. This structure uses an elongated web made from flexible water-tight material. This web together with hollow sleeves and maybe additional means are placed on a way of expected flooding. Then a ballast (weight) of sufficient height and width in the form of a wall (a stack) is established on this web, then this wall is wrapped up in the front and in the rear so that the edges of front part and rear part was not below estimate level of flooding. It is desirable, but it is not obligatory, said edge of the front edge has coincided with the rear edge end-to-end or with overlapping. Said edges can be connected to each other or to said wall by any known way. If a place where said barrier is mounted has ground depression then the front edge (and rear edge if necessary) can be increased by an additional strip of a similar material, using any known methods of water-tight connections, for example, by water-proof zipper, and superfluous material is fixed in the form of the folds. The wall can consist of blocks fastened among themselves or sections of RDFM, or sandbags, or separate elements (see below), at least a part of which is preliminary united in the form of the said blocks.

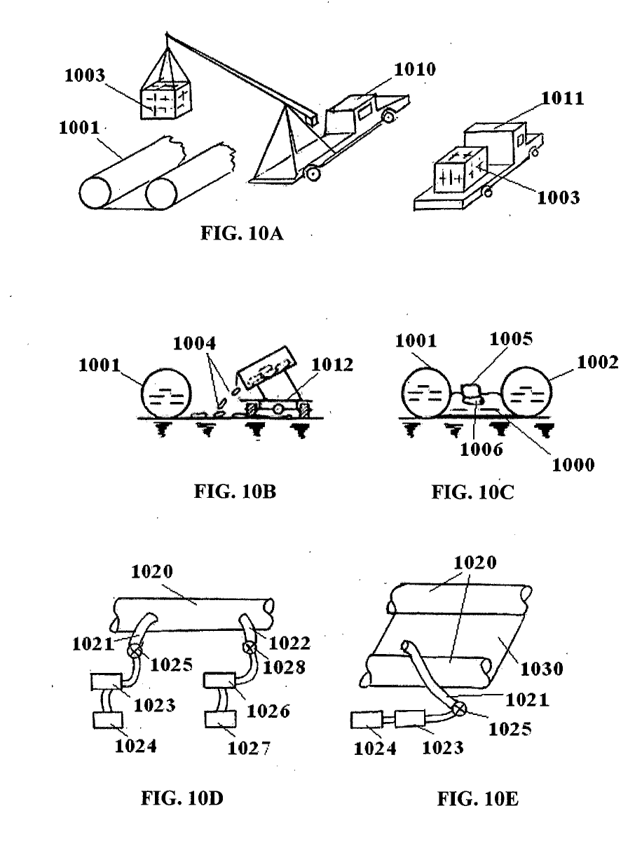

FIG. 10 shows some possibilities of accelerated installation of mobile dams on the basis of two sleeves located on distance from each other and connected by a web. FIG. 10A illustrates loading space that is located between sleeves 1001 by prepared and fastened heavy block 1003 with the help of an auto crane 1010 and a truck 1011. FIG. 10B shows loading said space by sandbags with the help of a dump track 1012. In this case rear sleeve can be filled later. FIG. 10C shows that is possible to fill the space between said filled sleeves 1001 and 1002 with water 1000 and to move said sandbags or blocks 1005 floating if preliminary said sandbags or blocks to supply with air bag 1006 having a air valve (not shown). Said valve can be opened in the place of destination by hand or by magnet or by radio.

The process of filling said sleeves with sand is shown by FIG. 10D. The sleeve 1020 has at least (a plurality of pairs) one pair comprising an inlet pipe 1021 and an outlet pipe 1022. The container 1024 is filled with sand that is placed close said inlet pipe 1023. This method does not demand a participation of a considerable quantity of people for filling of said bags, and the sizes of the containers are chosen taking into account of possible transportation by auto or air transport. In rest time these containers can be closed hermetically together with antiseptics for excluding of dangerous biological processes. Further sand from the container 1024 by means of a special pump 1023 that is adapted for material with abrasive properties (waste pump) is pumped over to the sleeve 1020. The second branch pipe 1022 is thus partially open for air removal. If necessary then sand in the container 1024 can be humidified with water forming a pulp (is not shown). After flooding this sleeve 1020 can be unloaded by the pump 1023 (or another) that is connected to said outlet pipe 1022. If it is necessary then the inlet pipe is connected the water pump. Another variant: said sleeves can be filled by dry sand with the help of a pneumatic jet pump. FIG. 10E shows similar variant of filling with sand the space between said sleeves 1020. It is possible the placement of a modular, collapsible plastic grid (Rapid Deployment Flood Wall-RDFW technology) between these sleeves (not shown) and following filling this grid with sand using a loader, excavator, bottom-dump, other piece of earthmoving equipment, or waste pump allows to mount quickly such dam not requiring “dry object” and to provide fast restoration of territory after flooding. Different variants, in which the space inside said sleeves is densely filled by heavy materials (sand, heavy blocks), allow to use air for filling of said sleeves that it is possible to execute much faster. But in this case the cross-section of such sleeves at the given height can be (and even should be) is reduced at the expense of, for example, internal crosspieces (connectors) as for mattresses, or in the form of a number of pipes densely adjoining to each other (not shown).

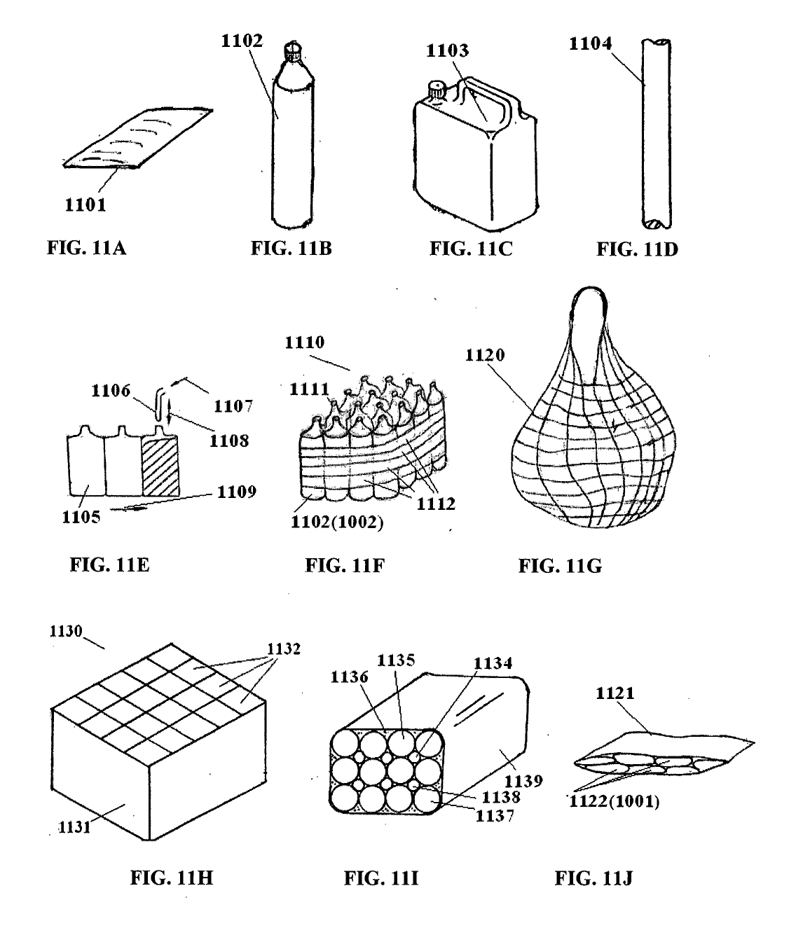

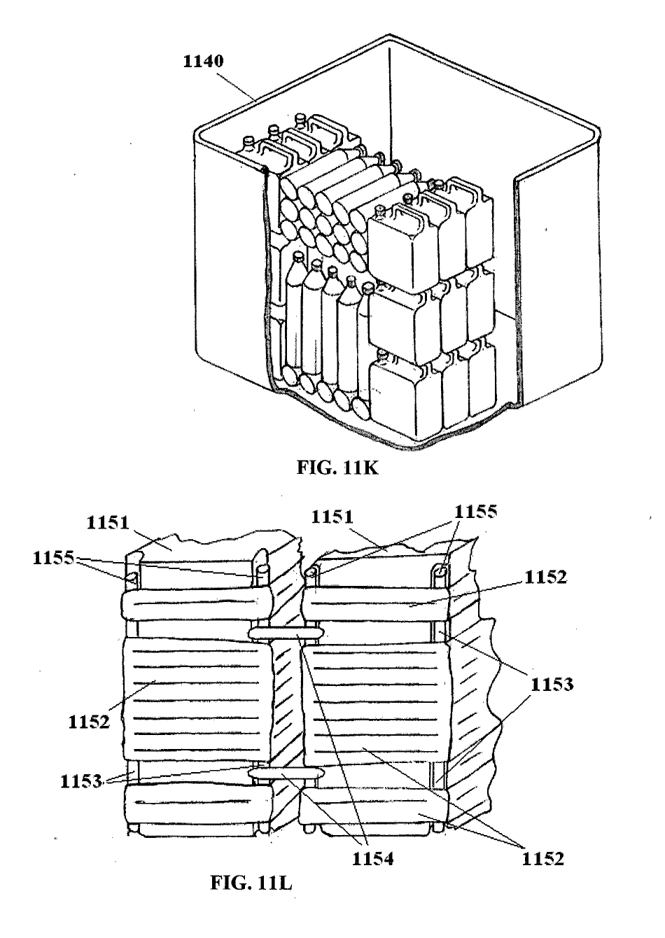

FIG. 11 represents several types of used elements. FIG. 11A-11D show the most widespread types of plastic canisters, including: a plastic bag—1101, a plastic bottle—1102, a plastic canister—1103, and a tube 1104 that can be filled with sand, water, or solid. As elements different capacities can be used, for example, common sandbags, metallic canisters and bottles, ceramic, cement or metallic tubes, elongated sleeves filled with water or sand and closed from two ends etc. The industry manufactures a plurality of similar capacities having different forms and sizes. A sand (or clay) filling process for can be automated, using pumps for materials with abrasive particles (waste pump) and schemes of conveyors and roundabouts that it is used by filling plastic bottles and canisters with liquid. FIG. 11E illustrates similar process. A set of said plastic canisters (bottles) 1110 moves along conveyor 1114. When said canister reaches a corresponding position it (is shaded) a branch pipe 1111 falls 1113 from above, nestling on a canister throat, and the pulp (sand) 1112 fills this canister. Then the branch pipe lifts, the stopper locks a throat of said canister 1110 (is not shown) and this line of canisters is displaced on the following position. It is useful to add in the sand any antiseptic. Similarly, new or used plastic bags (1101) can be filled with sand (or clay) in their manufacture.

The used plastic canisters (bottles) filled with sand together with wrapping up water-proof flexible material may give a cardinal solution of mobile barriers (dams). They allow almost completely excluding regular manual labor of volunteers on filling sandbags; allow using plastic canisters (bottles) repeatedly during several years. Inside sealed plastic canisters (bottles) filled with sand that is wetted by antiseptic a rotting and insects can not form as opposed to sandbags. It is allows to create technologically convenient and easily transported design and to use secondary canister (recycle).

FIG. 11 illustrates different ways formations of said blocks and modules from said elements for acceleration and simplification of barrier creation. All figures are represented in cross-section view. Bottles (or canisters) filled with sand (or water, or pulp) and corked with stoppers 1111 are grouped (as FIG. 11F) and are wrapped by a sticky tape or are densely packed into a film 1112, forming the wrapped connection block 1110. Such block can be packed tightly, or be only impenetrable for sand, or even only is mechanically fastened. A string bag 1120 (FIG. 11G) is convenient for transportation. FIG. 11H represents the box or crate 1130 which can have cells 1132 for installation of bottles, or without them. Its advantage is the accurate form 1131 and possibility stacking. FIG. 11I represents other type of said block 1139 (a cross-section view) that is assembled from bottles or tubes 1137 and 1138 having different diameters that correspond to “dense packing”. These tubes can be filled (1134, 1135) with sand; the gap 1136 can be filled with water, sand or can be not filled. Said fillers (1134-36) can be different, but not necessarily. Here and further such picture 1137 or 1138 can designate tubes or bottles. A bag (FIG. 11J) can be covered by a sacking or netlike stocking 1121 (a cross-section view) and filled with said plastic bags 1122 (1001) that are filled with sand. FIG. 11K shows an example of a possibility to use a “cubic” container or crate 1140 belonging to standardized tare filled with different bottles, containers, and other heavy objects (metal, stones, etc.), as intermediate container. The connectable blocks are not necessarily identical, and the blocks that are located above are not heavier than located lower. These bottles and/or containers can be filled with sand, pulp, clay, etc. It is important to achieve the greatest average weight of elements and blocks. Special forms of bags can be used to allow filling volume more densely. FIG. 11L represents a fragment of said wall (an example). Two adjacent sections 1151 (they are moved apart for clearness) include 4 solid tubes 1153 (or rod having special cross-section). These tubes are tightly wrapped up by self-adhesive thin film 1152. The sections 1151 are connected to each other by special means, for example, by latch hook (carabiner) 1154 that connect the corner pillars 1155. The section 1151 can be made on the base of FIG. 11F, FIG. 11K etc. The upper and lower ends of said corner pillars are located and/or protected by additional caps preventing disturbance of the surface web.

FIG. 12A and 12B represent two angular groupings of said bottles: 60° for the same bottles (1161) and 45° for different (1201 and 1022) diameters. FIG. 12C illustrates that different groups of tightly (density) placed bottles (tubes) 1203 can be connected by mesh 1204. Here and further the signs of “the star” designate that said object is not hollow (but sometimes this symbol is omitted). FIG. 12D represents a block 1210 like known “mattress”. Between grids (or continuous) 1213 and 1214 are placed bottles (or tubes) of two types—1211 (the big diameter) and 1212 (smaller). The crosspiece-connectors 1215 support a form of said block. FIG. 12E represents a rectangular block 1220 formed said plastic bottles (tubes) 1211 and flexible plastic bags 1216 packaged into a netlike bags 1217. FIG. 12F represents another embodiment 1230 of said “mattress” as a multilayer package that can uses the lateral tightening connectors as hooks 1215 on the ends. The bottles (or tubes) filled with sand 1211 are located between plastic bags 1216 filled with sand (or water), and this assemblage (said “mattress”) is surrounded with netlike envelope 1217. The cross-connectors are not shown. Such “mattresses” are re-usable during for long time. They can be easily fastened to each other. FIG. 12G illustrates that the radiuses 1211 (R) [symbol] 1212 (r) must be equal (an arrangement with displacement—FIG. 12A) or satisfy to a ratio 2R²=(R+r)² as FIG. 12B shows it.

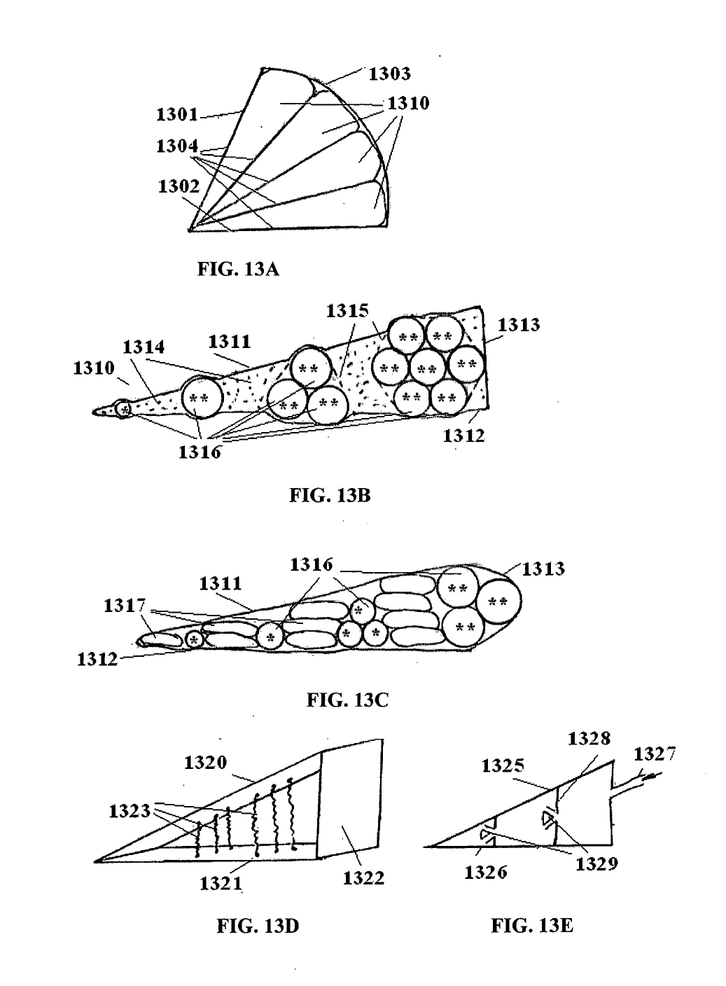

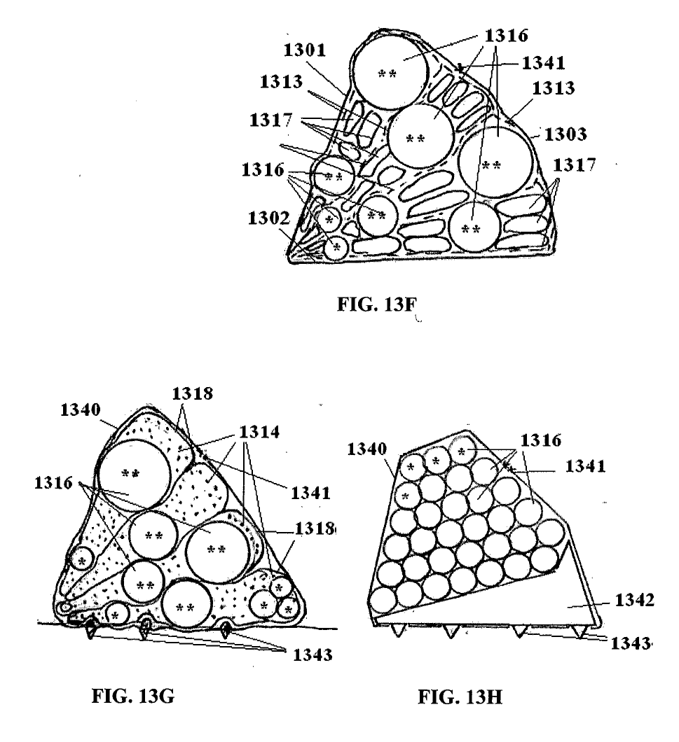

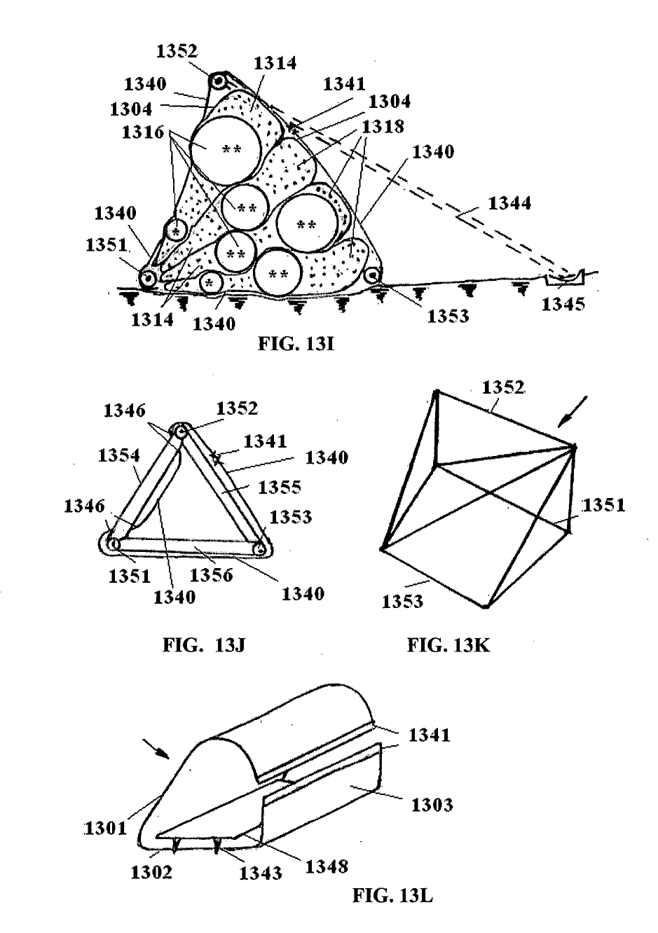

FIG. 13 shows the simplified variant of a barrier suitable for protection of separate structures, for example, houses. It is supposed that the equipment for protection against flooding can be prepared in advance. Usually flooding repeats in the same places. The barrier basis is a set of wedge-shaped sections. The wedge-shaped section filled with sand (clay), wherein can be located bottles and/or tubes filled with sand (clay or water). Said bottles (tubes) are placed one by one or dense groups so that diameters of these single bottles (tubes) or groups increase, as possible, at removal from the wedge edge, and their size is slightly more than distances between the walls of the wedge forming cambers. These sections are stacking against each other so that the said cambers of adjoining surfaces of the adjacent sections would be alternated, and the arrangement of said cambers should provide this possibility. The quantity of these stacked sections is that that they form an acute angle of the predetermined value. The value of this angle should be close to right.

FIG. 13A illustrates a cross-section of a structure of special mobile dam that is intended generally for separate building protection. It is shown a front part 1301, a middle part 1302 and a rear part 1303 of said elongated strip. Such design uses wedge-shaped blocks and can have a height no more than 1 meter. FIGS. 13B-13E represent different types of wedge-shaped blocks. Inside wedge-shaped blocks 1310 formed by the top, bottom and back walls 1311, 1312 and 1313 (FIG. 13B) and lateral walls (not shown) are accordingly placed said bottles (or tubes) 1316, the diameter of which increases (on the average) in a direction to a back wall. Lateral walls here and further are not shown. The block FIG. 13C includes a group of said plastic bags 1317 filled with sand, clay or water. In this design the fillers 1316 and 1317 can be identical or different. The block FIG. 13D has corresponding rigid walls 1320-1322, and it is intended for filling with sand, clay or water. For maintenance form it can be used connectors 1323 (like known “mattress”), a length of which increases in a direction to a back wall. Walls said blocks can be made in view of plastic flexible or solid, water-tight. FIG. 13E represents a block divided by water-tight walls 1328, connecting a top wall 1325 and a bottom wall 1326 and having valves 1329 build-in directly in walls 1328. These valves can be opened only in the direction (for example) of the acute part of said block. Such design is intended for filling with water through an inlet 1327 placed in the back wall.

FIG. 13F-13I represent a few variants of mobile dam sections on the base of said wedge-shaped block. The width of said blocks and sections is defined by convenience of these blocks use and is approximately equal to one meters. At forming said dam these sections are established on a water-proof flexible strip closely and fixed in these positions, adjacent sections are connected among themselves with the help of any connecting means (not shown). After wrapping up the specified number of these sections by said web two edges of this web are connected directly or through said sections that forms the sleeve (closed or not closed). If the established barrier bends around protected object usually then back walls of these sections are fixed closely to each other, a backlash is formed between front walls of adjacent sections, but this backlash influences on efficiency of such dam a little. A set of said wedge-shaped blocks 1310 and their walls are shown inside said envelope (1301, 1302, and 1303). FIG. 13F details this structure. Said wedge-shaped blocks include bottles (tubes) 1316 and other. Inside said envelope may be used the netlike envelope of each block 1313. The space between said bottles (tubes) is filled with sand (or water) bags 1317. The place of connection 1341 of said front and rear parts is shown on FIG. 13F. Following barrier FIG. 13G includes the blocks having the envelope 1318, and therefore the space between said bottles (tubes) can be filled with sand (or water) directly. The teeth 1343 for fixing on place can be fastened to said middle part 1302 directly or using eyelets fixed in said part 1302. FIG. 13H shows other implementation of such barrier that includes tightly located the tubes (bottles) 1316 having same diameters. The inclined pallet 1342 provides the necessary slope. Really each section (tubes, bottles) have the limited width. A placement of such sections possible closely and enough long continuous strong web-cover allows to create a reliable barrier. Besides, such sections can be additionally connected among themselves.

FIG. 13I illustrates additional possibility of installations tubular (from metal or plastic pipes) skeleton 1351, 1352 and 1353 which increases barrier stability, for example, using the additional support 1344 leaning against buried concrete blocks 1345. FIG. 13J shows that the front part of said web 1340 leans on internal barrier consisting of said wedge-shaped blocks. It is shown that said front part rounds the tube (beam) 1352 and 1351 using eyelets 1346. Such skeleton (FIG. 13K, one fragment-section) plays a supporting role only. The arrow shows the flood direction. The main tubes (beams) 1351, 1352, and 1353 correspond to FIG. 13J. Other tubes (beams) are supporting stiffness. FIG. 13L illustrates said front part of said web 1301, said middle part 1302, and rear part 1303, a connection line 1341 and said teeth 1343 for fastened to ground.

The sizes of such sections and blocks should be compatible and to correspond to chosen standard system as like the standardized product tare. The height of said barrier wall has to be sufficient to provide the protect for given the terrestrial surface profile along the said predetermined line and the expected height of flooding so that the barrier upper edge has been located approximately horizontally, irrespective of roughness of the terrestrial surface. The depth (the size in flood direction) of said barrier has to provide said mobile dam stability and resistance to flooding. Said depth and rear buttresses impede overthrowing. The teeth (or plugs in the presence of preliminary buried blocks with sockets) and roughness of lower surface impede displacement.

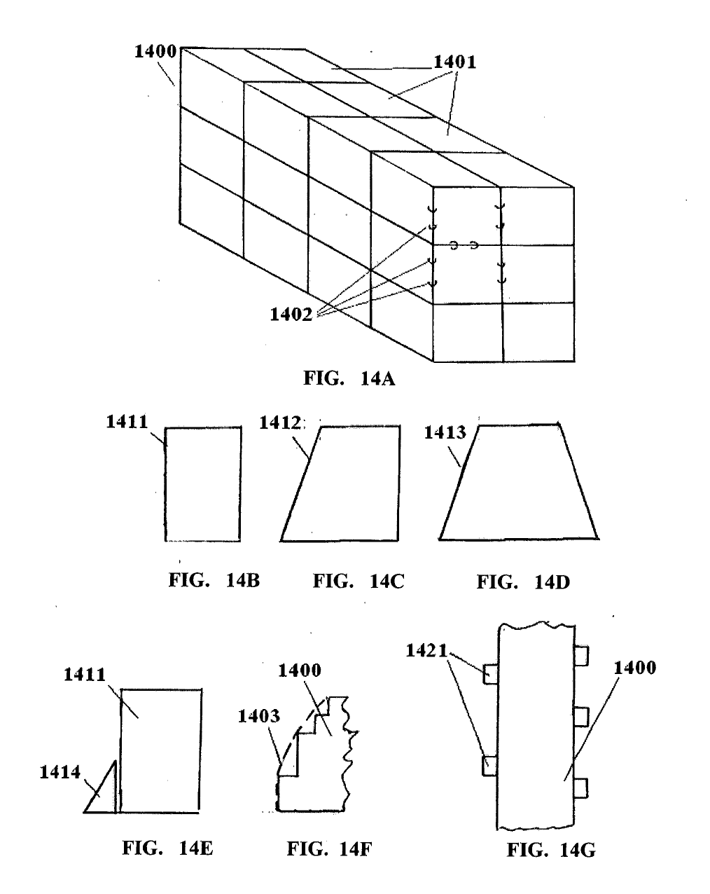

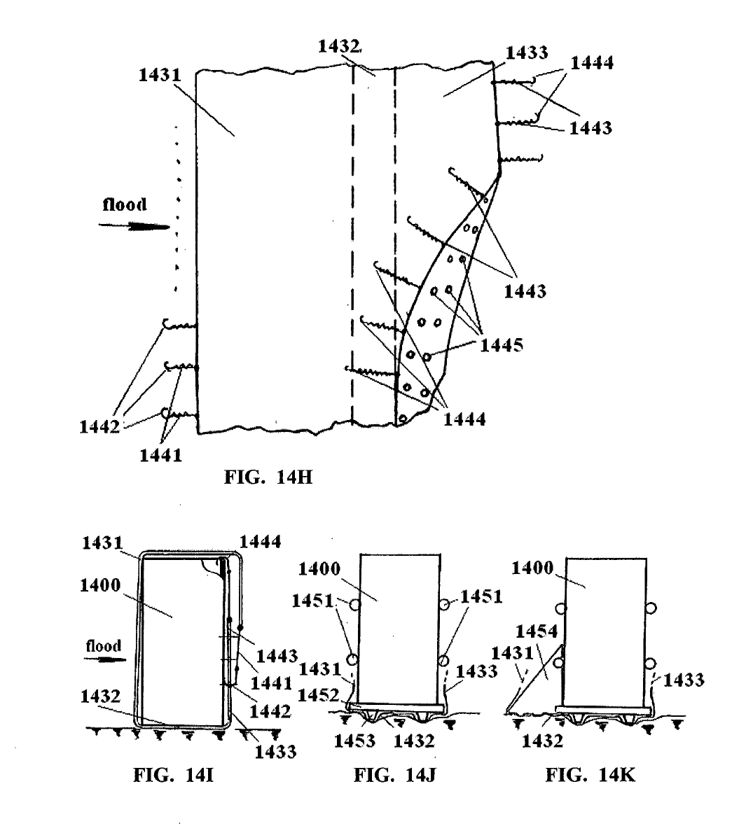

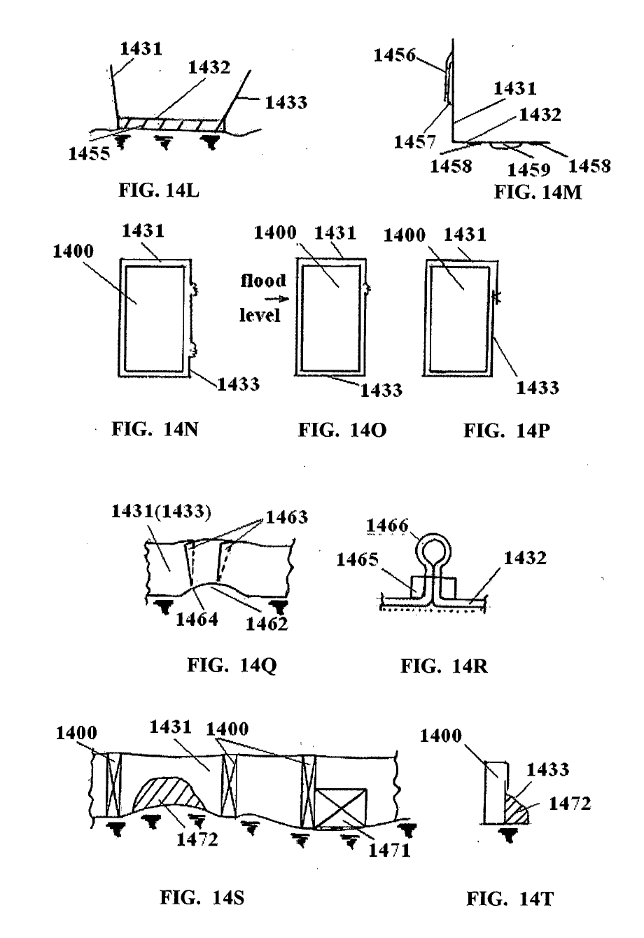

FIG. 14A shows a wall 1400 which is a basis of a protective barrier. This wall can be made, for example, from cubic container 1401 connected among themselves 1402. In other cases such wall can be made from blocks 1110 (FIG. 11F), or 1130 (FIG. 11H), or 1140 (FIG. 11K), or 2120 (FIG. 12E), connected a sticky tape or same other way, or in the form of RDFM barrier (Geocell systems Inc.). Possible forms of cross-section section are presented further as rectangular 1401 (FIG. 14B) or trapezoidal 1412 (FIG. 14C) and 1413 (FIG. 14D). The last form increases the barrier stability. Said buttresses 1414 can be attached to the wall 1411 (FIG. 14E) or are executed in shape of steps 1403 (FIG. 14F). The water-tight web can have a pattern taking into account said buttresses, or these buttresses can be lengthened with the help in any known way (clamps, glue, welding, and capture). FIG. 14G shows one of possible ways of said a buttress location.

FIG. 14H and FIG. 14I illustrate a stages of said flexible water-tight web-cover 1431-1432-1433 (correspondently, a front, a middle, and a rear part). The width of said web in the direction of the arrow “FLOOD” is defined by the height of said barrier that is chosen on the base of flood forecasting, and the necessary width, defining a stability of said barrier and depending on weight of ballast (weight of wall 1400, FIG. 14A) and additional fastening. Said web is laid into ground place along the predetermined line of protection and so that said front part 1431 lies opposite flooding. The length of this web is defined by necessary length of said barrier. It is possible, if necessary, separate adjacent segments of said web to connect using water-proof zipper or other means. After installation of said wall said rear part 1433 said web is lifted and is fixed by, for example, elastic cords 1443 having hooks 1444 on their ends on the top part of said wall (FIGS. 14H and 14J) or according to FIGS. 10E-10I. Then the front part 1431 is laid on the top of the wall so that its edge covers said bottom part 1433 and is fixed in this position (using the similar hooks 1442). The hooks 1441 can be fixed in special loops 1445. The edge of the back part 1433 should be located to the wall 1300 closely to the top part, but no lower than expected flood level.

FIG. 14J shows that said wall can be mounted on pallets 1452 so that ledges 1453 are located in parallel to the barrier (FIG. 14J and FIG. 14K). Besides, these figures show a possible position of the buttress 1454 and tubes 1451 of a probable skeleton (not shown). A hydrophobic layer 1455 for infiltration reduction from below can be fixed in lower part of the web 1432 (FIG. 14L). FIG. 14M illustrates additional means intended for protection of a front part 1431 of said web against sharp floating objects A protective layer 1457 in the form of strong elastic covering (continuous or layered) or a chamber filled with water (air). This layer can be preliminary fixed on said front part of the web or later. In front of this protective layer 1457 can be closed a chain armor (or a grid) made of strong plastic or a composite. Elements 1458 can be fixed from below said web. These elements can serve as nests for installation of pins as anchors for strengthening said mobile dam on the place or plugs for fixing into sockets fastened into the buried blocks. FIG. 14N-14P show three variant of the web placement and its fastening. FIG. 14Q shows folds 1463 forming in a depression place 1462. FIG. 14R shows a fold 1466 in bottom part 1464 of the web 1432 and its fastening by a clamp 1465. FIG. 14S and FIG. 14T illustrate external fastening of said barrier by means of additional ballast 1472 or additional external wall 1471.

The mobile barriers according to FIGS. 11, 12 and 14 are intended for protection of different areas in the case of high flood level (1-1.5 meters), the mobile barriers according to FIG. 13 are intended for separate dwelling houses and buildings in the case of middle flood level (up to 1 meter). It is known that 90% of flood damage in the United States alone is caused by flood having height in less than 1 meter of water. On the base on the proposed solutions the author considers the possibility of creating a number of structures that are useful for flood protection, including: basins-traps, artificial drains for floodwater, protective barriers to create ways of people evacuation.

FIG. 15 illustrates ways of reduction of infiltration from below. FIG. 15A shows the example of the barrier made from a set of sections 1500 of the wall (1300, FIG. 13A) mounted close to each other and that are covered by said web-cover 1501 (the front edge) and 1502 (the middle (bottom) part), correspondently 1331 and 1332 (FIG. 13). FIG. 15B illustrates a possibility of closing the angular slit 1505. Flexible balloon (sleeve) 1511 closes said slit 1505 from the front after its filling with water (or air) 1510 through inlet tube 1513 having hard walls, and water flow pressure “flood” deforms said balloon (sleeve) 1511 and presses it against the wall 1500 and ground. The second balloon (sleeve) 1512 closes said slit from behind. The form of said tube 1516 prevents the penetration of said balloon (sleeve) 1511 into the space 1517. This space can be filled with the second balloon 1512 or with some means. FIG. 15D shows top view of one variant of this unit (1511, 1512 and 1515). FIG. 15E shows a “crawler” 1520 (a view from below). It increases traction between said barrier and ground. This crawler comprises a plurality of teeth 1521 (FIG. 15C). The sharp point 1522 is fastened to crawler 1520 and sticks into ground passing through the eyelet that is made in the water-proof web 1523. Two layer of flexible material 1524 and 1525 compensate ground roughness and interfere with water leakage.

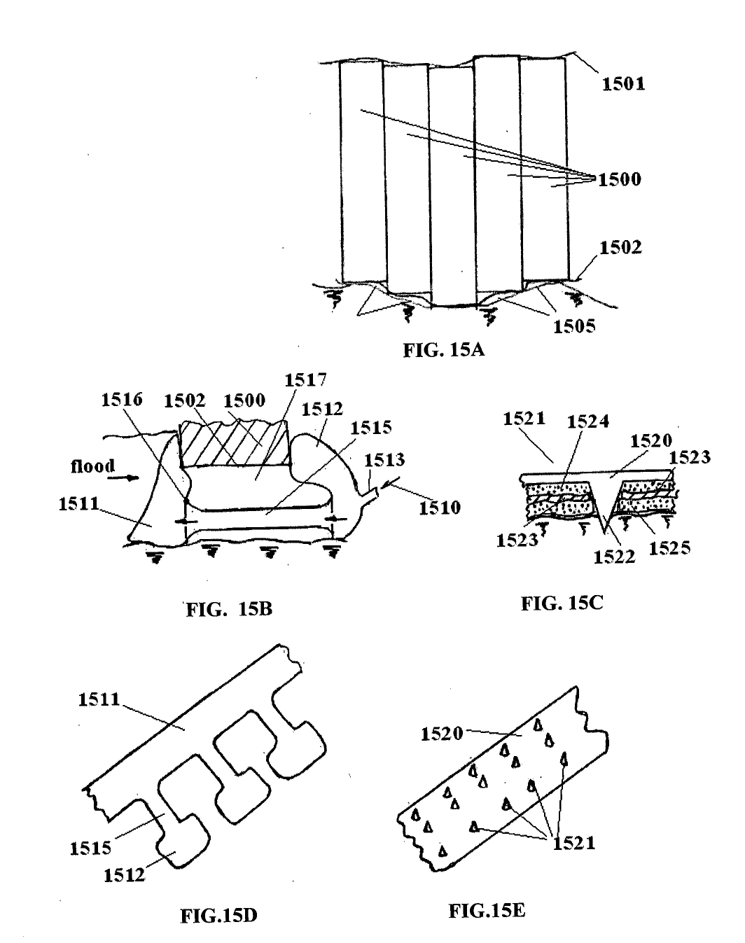

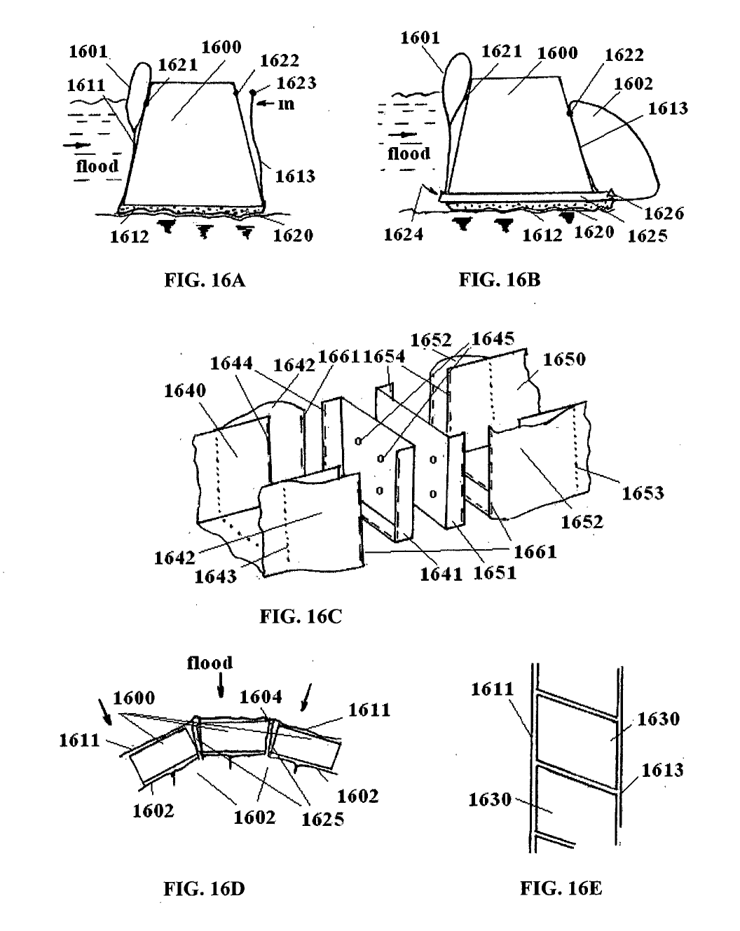

The needs of manually fastening during to flooding are difficult or even impossible. The variant FIG. 16A allows to simplify and to automate the lifting of front edge 1611. The wall 1600 is placed on the bottom part 1612 of said web and a flexible layer 1620. The elongated sleeve 1601 filled with air is fixed to front part 1611 of said web and is capable to lift the front edge of the web together with water level. Water pressure presses said front end to the wall 1600. When water level will reach predetermined value then the front edge can be fixed by an automatic clip 1621 (by a magnetic or any another catcher). The rear part 1613 can be fixed manually by 1622 and 1623 or automatically (further). FIG. 16B illustrates a possibility of the lifting of said rear part 1613 together with the rear sleeves 1602 that is filled with water and can be fixed by clamp 1622. It is shown that rising water pressure can to fill said rear sleeves 1602 through thin rigid tube(s) 1625, an inlet 1624 and an outlet valve 1626. Said rear edge can be lifted and fixed with the help of a truss or ribs of which are tubes made from bendable and not expanded material. The rear part of the web can be fixed to said truss. This truss is connected to, for example, air or water pump and then said pump will inflate said truss, and the rear edge will lift and can be fixed to the wall (not shown). FIG. 16C illustrates a possibility of said dam construction from several big parts, each of which can include a lot of separate sections. The left trough 1640 made from said web represents a left part; the right trough 1650 represents a right part. These two parts can be connected directly 1661 or through dividing end partitions 1641 and 1651. These partitions can be connected to corresponding parts by means of 1644 and 1654. In this case the ended sections can be fastened though eyelets 1645 mechanically. The design can include additional web troughs 1642 and 1652 that can be connected to each other by 1661. The connections 1644, 1654 1661 etc. can be made as welding, gluing, or water-proof zipper. The portable air compressor allows not being afraid some sand. FIG. 16D shows a place where said dam turns. Clearances 1604 between adjacent sections 1600 allow using it for said tube(s) 1625 placement. FIG. 16F shows a top view of this barrier. The parallelogram-shaped container 1630 allows, at least partially, blocking the path of water infiltration.

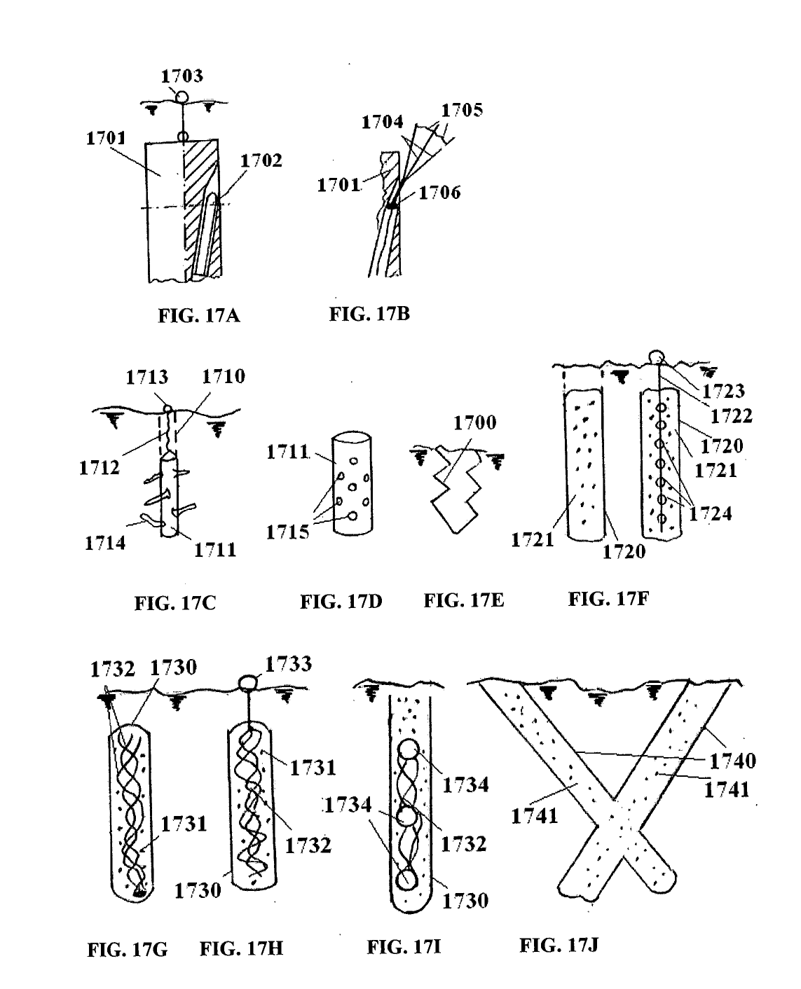

It is useful to strengthen such barrier additionally on the ground. There are many designs using buried concrete blocks having knots for attaching ropes (not shown), which allow to anchor (fix) such mobile barriers in the land. This is a good solution, but their installation is very time-consuming. It is necessary to dig deep enough holes, then install said block, and then fill up this hole so that said block was securely fastened. The greater the depth and block size, the more labor-intensive said block installation. FIG. 17A and FIG. 17B illustrate one variant a mechanically extended anchor for the installation of which is sufficient to drill a narrow hole (well) in contrast to the previous ones. A cylindrical housing 1701 included one or more plug-in modules 1702, which are pushed (by the explosion, by means of spring or other) of the housing 1701 and moves into ground. Then, under action of own elasticity a guide 1704 (FIG. 17F) connected by membranes 1705 moves apart, remaining attached (1706) to the housing 1701. When pulling for the outer ring 1703 such anchor firmly retained in the soil.

FIG. 17C-FIG. 17D shows that in pre-drilled deep hole 1710 pulled down a cable 1712 connected to a ring 1713 (or any other node of fastening) that remains on the earth surface. The hole is filled with swelling mixture (for example, NIPA) directly or this mixture preliminary fills a cylindrical container 1711 including a plurality of openings 1715. With swelling (absorbing the moisture of the soil) this mixture widens and penetrates into ground through said openings 1715 forming an “anchor”. FIG. 17E shows possible profile 1700 of said hole that is useful for this and following designs. Lateral grooves 1715 forming in drilling well help to fix such “anchor” inside the ground.

FIG. 17F-FIG. 17G show a well 1720 that is filled with Non-Newtonian mix 1721 (for example, Stewart Penny) that is capable to become hard by strong forcing (tension). A cable 1722 is pre-placed in hole 1720 together with a ring 1723 and beads (widening) 1724, after that covered with soil, and then such structure becomes an anchor by sharp blow. Another variant uses fiber bundle 1732 pre-placed into similar hole 1730 (FIG. 17G-FIG. 17H). These fibers 1732 have to make from material having negative Pascal coefficient (for example, Zetix). Such bundle is capable of widening by strong forcing (tension). The ends of said fiber can be connected to ring 1733 located on earth's surface. Said fiber can be covered by widening elements (or beads, balls) 1734 (FIG. 171). FIG. 17J illustrates improved embodiment, wherein several inclined holes 1740 drilled so they can intersect to each other at depth. In this case intersecting mixes or fiber bundles form an integrated structure that is very firmly fixed in the ground.

These non-traditional anchors can be used not only for fasten of mobile dams (barriers), but also to combat landslides and mud flows. Many small holes (wells) being drilled during the dry season in the dangerous slopes (beginning with upper sloping part) and that are filled with said Non-Newtonian mix or said fiber bundles allow significantly strengthen such slopes. The beginning shift can sharply increase the rigidity of attachment, which hinders the development of shear. Such thin wells (holes) do not violate the stability of the soil.

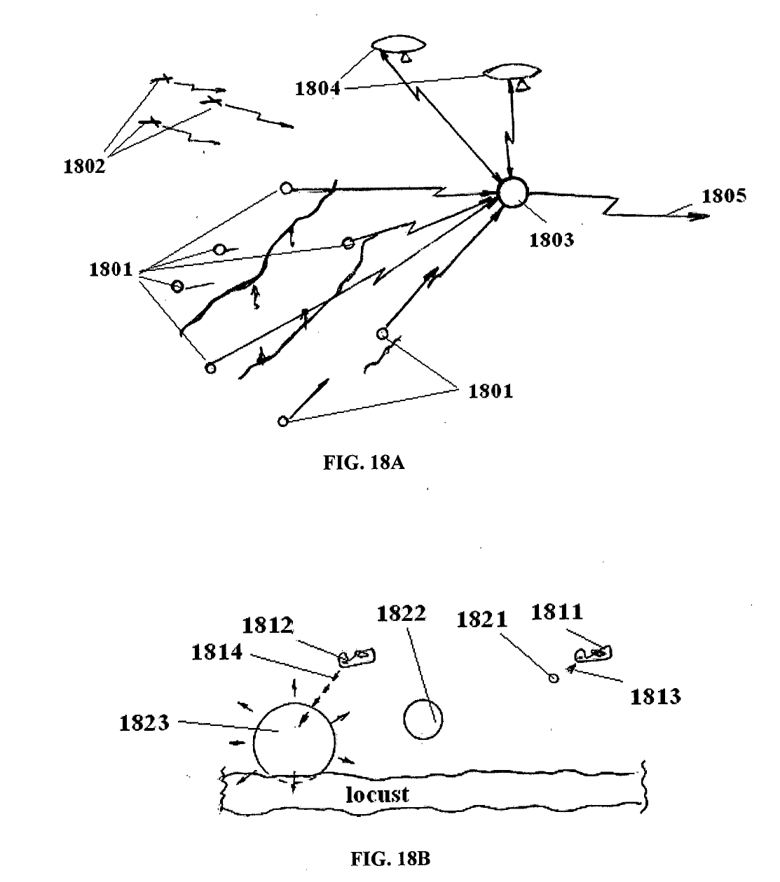

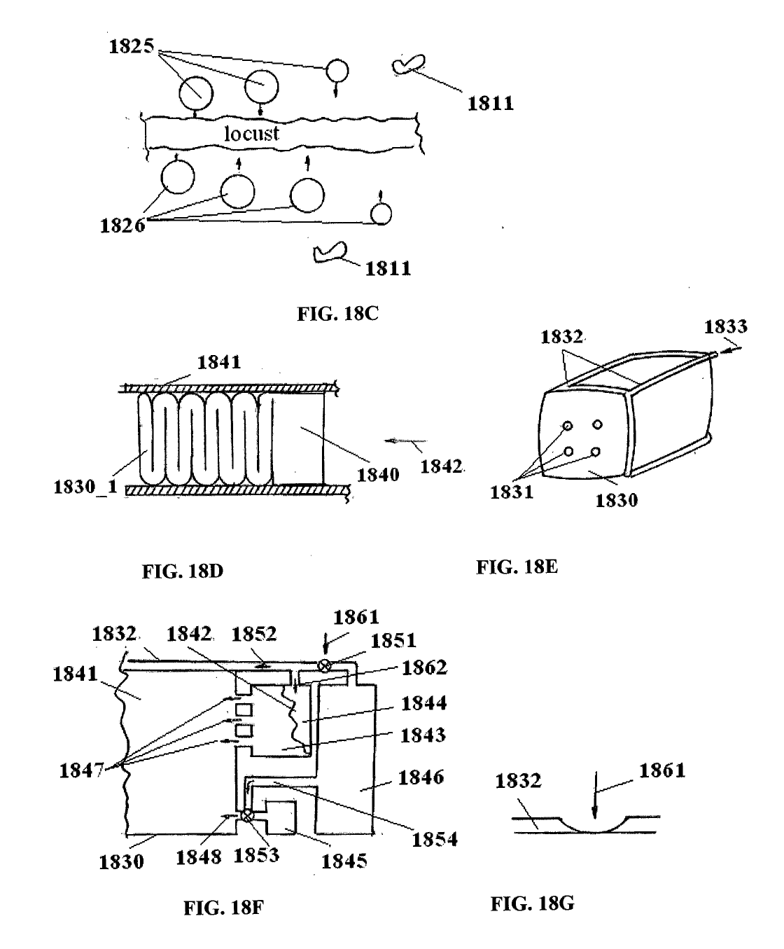

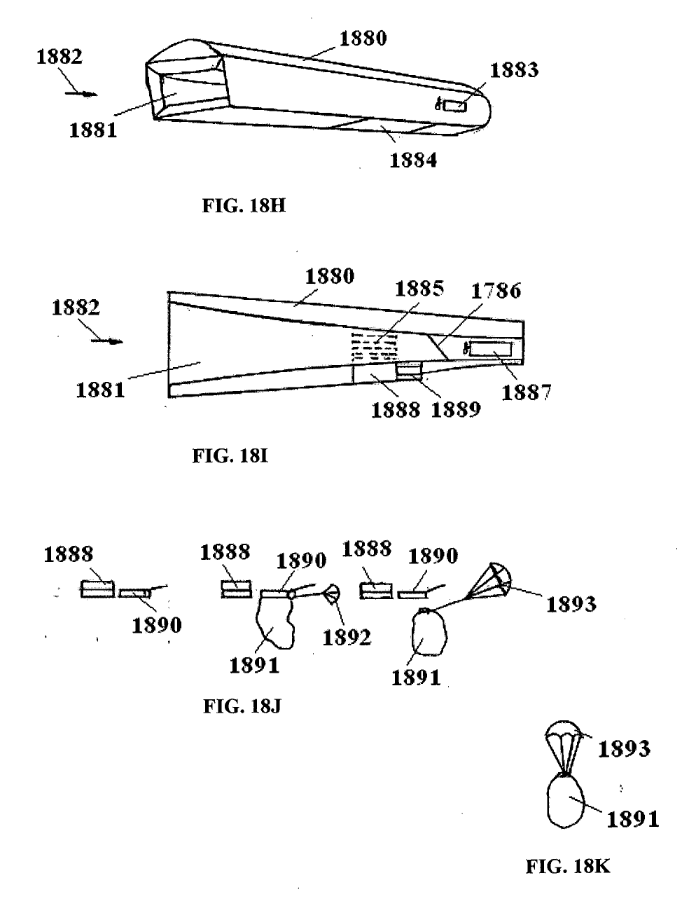

FIG. 18A represents a diagram of a system of protection against temperature-depended dangerous caused by covering (flooding) large dry area with organic mass (mainly locust, rodents). This system can comprise one or more ground-based sensitive mini-devices 1801 and/or one or more flying sensitive devices 1802 mounted on UMAVs. Each of said devices includes one or more sensors. These devices have means of telecommunication and are connected to one or more central stations 1803. These stations can be connected to additional aircrafts (dirigibles) 1804. The stations 1803 are capable of analyzing all information received from said means 1801, 1802, 1804; are capable of determining a moment of locust danger, and transmitting this information (1805) to corresponding manager. The ground-based devices 1801 can be used some technology according to technology “smart dust” and can include: an analyzer of sounds that the locust blows going to or being in Gregarious Phase, and a chemical analyzer of pheromone, which the surface cells of the skin of males emit in the case of a large gathering of individuals. The flying devices 1802 can include at least a sound analyzer and a video and an image recognition apparatuses. The ground-based devices 1801 can include the chemical analyzer and the sound analyzer. Said chemical (smell) sensor can use a generator having an oscillating quartz plate, a part of said quartz plate is covered by protein molecules that take smell molecules and correspondently change the oscillation frequency. Chemical sensor can be used the change of color, for example, a violet color-FeCl₃by detecting “guaiacol” (pheromone). The color recognition (Gregarious Phase is characterized by black or yellow color) and locust mobility. The sound analyzer marks the sound of “Gregarious Phase”. This analyzer can mark a dangerous alarm signal of rubbing feet out other signals (“song of opponent”, “calling”, “courtship”, etc.) in the range of tens kHz approximately, using spectral analysis and etalons. A plurality of similar sensor information jointed together with said center in united information system. The combination of several types of the sensors allows more precisely diagnosing a locust behavior, combination of ground-based and flying means allows detecting when locust transforming to Gregarious phase and to provide supervision over said swarm.

The possibility exists of an artificial initiation of locust transforming into said Gregarious phase when shoots have not risen yet or after harvesting is offered. The locust depression period can usually continues up to 11 years, although deviations happen sometimes (for example, in Kazakhstan the phase of mass reproduction and high injuriousness of locust lasts 2-3 years, and then within 5-6 years rather low number of insects is observed). Said artificial initiation in more safe time when there is no, at least, partially green vegetation, allows to destroy easier locust swarm, and, as it is known, in the absence of food the locust starts to eat each other. The transformation initiation in predetermined time can give a possibility to rest green vegetation.

Said initiation can use next means in boxes: 1) sound simulators of said friction of locust feet, 2) smells pheromone, 3) boxes having the transparent perforated walls and filled with the groups of locust in the Gregarious phase. The sizes of perforated openings are less than the locust sizes. A set of such boxes can be scattered in areas in the period when it is possible to expect that locust awake from depression, and also if temperature and humidity conditions allow this transformation. The locust for filling of these boxes can be grown up in terrariums where special conditions (the raised temperature of 35-40 degrees, for a deserted kind-even to 456, humidity of 30-35%, illumination and etc.).

Extended upwards plastic tubes can be used for destruction of locust swarms as passive traps. Their wall must be transparent as possible. These pipes can have in horizontal cross-section a closed form (round, oval, rectangular) or a spiral form having a bell-mouth in direction of an expected locust arrival, or combined. The bottom part of these tubes (for spiral and on a lateral surface) can have green color (inedible or including any anti-locust material), and/or the equipment for locust killing and its removals.

Other means are air means for destruction of swarms. They can include flying airplanes for scattering of explosive removers or dirigibles-cachalots for absorption of locust. In the case of swarm detection a group of airplanes (500-600 km/hour) or gliders (to 300 km/hour) on possible closer distance flies over/under said swarm (tens meters). To not worry locust the flights has to be carried out by gliding airplanes or gliders. The flight over even the biggest swarm can take not more half of hour. The first embodiment includes a spraying fuel-explosive fuel in the form of clots in the direction of said swarm and subsequent explosion of said fuel. Real conditions of swarm flights (small speed of wind, absence of rain) promote application of the offered method (FAE is very sensitive to weather conditions). It is known that damaging action of Russian flame throwers RPO-A, having 2.2 liters of fuel, is equal to 50 qu. m. for people. It is possible to estimate this value for locust as 200. Therefore, the two-liter clots should be thrown out at every 100-200 meters. The additional time gap can appear necessary that previous explosion previous has not set fire following which has not reached flammable concentration. For this purpose a time interval 1.5-5 sec is necessary. The set of connections and mixes which can be used as FAE is known: ethylene oxide, propylene oxide, mixture MAPP, methyl, butyl, etc. Materials that are capable to ignite spontaneously in air (for example, triethylaluminum) and UV laser rays can be used for detonation.

FIG. 18B illustrates process of struggle against a swarm. At first the first plane 1811 flies by over the swarm surface and splashes out 1813 a fuel clot 1821. Simultaneously, it informs about it the following plane 1812 optically or y radio. In the meantime said first clot evaporates and as gas cloud extends, mixes up with air (a sequence 1821-1822-1823 shows) and gradually descends. Speed of such gas diffusion can be increased at the expense of high-molecular additives. At a position 1823 this cloud reaches the necessary concentration, and with the predetermined delays the second plane 1812 lets out bullets-detonators 1814 that initiate explosion 1823. After this the cloud 1822 reaches necessary concentration and further this process repeats. The planes 1811 and 1812 move synchronously. The width of swarm defines necessary quantity of planes. It is desirable to use gliders or planes having the engines protected from locust. FIG. 18C shows attack from above and from below. Accepting that the density of swarm reaches 50-70 individuals on m² and weight of one individual approximately 2 grams the locust swarm increases density environment approximately on 0.7 kg/m³, i.e. by 60%. It is enough that having average density of 1.6 swarm stops said containers falling. The start of such containers containing the chamber with easy gas is possible and from Earth surface. It is possible to create an intellectual system for fuel spraying that is capable to change of structure of said cloud in the given direction.

FIG. 18D shows an example of folded extendable container. It is located, for example, between walls 1841 of pneumatic “pusher” that is capable to push out 1842 this container. The envelope 1830_1 of said container is folded and compressed. The equipment 1840 is behind placed. FIG. 18E shows the pushed out container. The compressed gas 1833 pressure inflates tubes 1832 (or due to elasticity of material or artificial muscles), and further this container extends sucking in air via apertures 1831.

FIG. 18F shows a scheme of said extendable container. It includes two or three chambers: a main chamber 1841, a FAE chamber 1842, a chemical detonator chamber 1845 (if it is used), and a cylinder 1846 (if it is used) filled with compressed gas (air). The chamber 1842 can be divided into two subsections 1843 and 1844 by flexible partition. In the beginning the chamber 1843 is empty, said FAE is in the chamber 1844. Valves 1851 and 1853 are closed. For example, the valve 1851 can be pressed (1861) by wall 1841 (FIG. 18D). The valve 1853 can be compressed by pressure in a balloon 1846. After pushing out the external walls cease to be pressed (1861), a part of compressed air 1852 (1833, FIG. 18E) being in said cylinder 1846 inflates a tube 1832 and extends the envelope of said container, other part 1862 inflates a subsection 1844 and pushes out FAE from a subsection 1843 through apertures 1847 into the main chamber 1841. Simultaneously external air is sucked in through apertures 1831 (FIG. 18E) of main chamber 1841 and is mixed up with FAE. The sizes of said apertures, the pressure and the elasticity of the envelope are chosen so that after swapping FAE in main chamber 1841 the concentration could reach the value that is necessary for explosion. Such container is protected from an external wind and can fly expecting detonation. The chemical detonator can be pushed out (1848) from the chamber 1845 in main chamber through the valve 1853 that opens when pressure in a cylinder 1846 will fall below the given level. FIG. 18G illustrates an example of the valve 1851, and it is similar 1853.

FIG. 18H illustrates an example of another way for locust swarm destruction. A large-sized dirigible 1880 has a through longitudinal hollow channel that has a wide entrance aperture 1881 and gradually narrowed to a tail. At movement the dirigible 1880 meets said swarm and sucks in locust 1882 through an entrance aperture “mouth” 1881. Screw engines 1883 are located in stern part. Inside said channel one ore more engine 1887 are located (FIG. 18I). They suck in air flow together with locust through the entrance aperture 1881. The dirigible fuselage has a hatch 1884 in a back part of the fuselage. An apparatus 1885 for locust killing is located inside the channel over the hatch. It can comprise either a plurality of bare wires connected to a high voltage source, or a laser radiator. From behind said apparatus 1885 is placed a partition 1886 having a plurality of openings (those size is less that locust size) and that closes the way to the stern and reflecting downwards a stream of dead locust in the direction to said hatch 1884. Under the hatch it is located blocks 1888-1889. It can be the device 1889 collecting killed locust for storage 1888 (the first embodiment) killed locust. It can be devices collecting killed locust for filling of bags arriving from storage bags 1888 (the second embodiment). Following FIGS. 18J-18K illustrate consecutive steps of filling of bags 1891 with locust and parachuting these bags downwards 1892-1893. During filling the bag 1891 hangs being fixed in a holder 1890. After filling (controlling the volume or weight) the killed locust falls through said hatch 1889, and then an exhaust parachute 1892 pulls off the filled bag, clamps a bag mouth and extends the basic parachute 1893. The bag falls on the earth and said locust can be used as the organic materials.

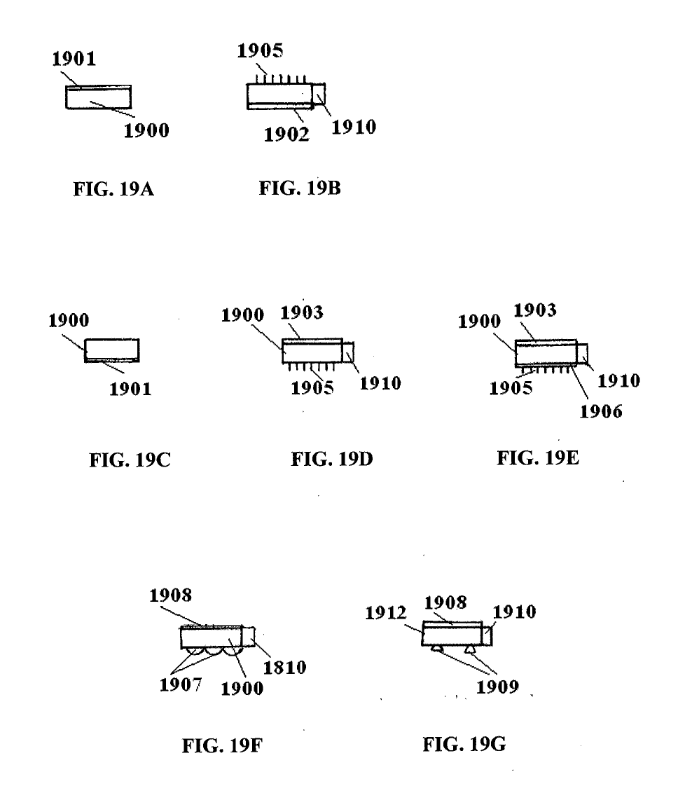

FIGS. 19 represent different applications of said membranes and their structures that allow to reduce the sun radiation flux reaching Earth's surface. These membrane comprises the thin film 1900 (for example, 5-20 micrometers), the upper surface of which is covered (FIG. 19A) with thin well reflecting layer 1901 (Al, 5-10 micrometers thickness). A plurality of said UMAVs having such membranes are capable of forming said screening cloud and of reducing the solar energy flux reaching Earth's surface. Such cloud can be located at predetermined altitude including stratosphere. Moreover, the higher will be located this cloud, the most part of incident solar energy will be reflected into cosmos. A set of thin flexible solar cell (not shown) can be placed on said upper surface of such membrane. This embodiment is intended for using during daylight hours. FIG. 19B (like FIG. 4B) shows a possibility of moving away a heat that Earth's surface radiates at night. The layer 1902 absorbs this heat, and nano-antennas 1905 can radiate this heat to cosmos. The layer 1902, and also the layer 1903 (further) can have a plurality of small convexities allowing receiving sun light from abundant quantity of directions. The simplified variant (FIG. 19C) comprises only reflecting layer 1901 for nighttime operation that allows creating local “greenhouse” local zone. Three variants (FIGS. 19C-19E) are necessary not only for “Global cooling”, but also at sudden or abnormal frosts which very often cover North America and Europe. The next FIG. 19D-FIG. 19E are recurrence of FIG. 4B. FIG. 19D is intended for daylight hours. The upper layer 1903 (or corresponding semiconductor layer 1903) comprises a plurality of wideband sun radiation receivers. They receive sun radiation energy; transform it into direct current source that provides the high frequency generator and nano-antennas 1905. These antennas radiate within one of zones that are transparent for atmospheric gases. The UMAVs using such membrane have to fly above ozone layer and to receive solar energy including that part of this energy which would be spent for ozone formation and energy of an ultraviolet that would be detained by this layer. FIG. 19E is improved FIG. 19D embodiment, in which the lower surface of said film 1901 is covered by reflecting layer 1906 for reflection of Earth's radiation and can be used for nighttime. The accumulator 1910 (FIGS. 19D-19E and further FIG. 19H and FIG. 19I) shows (conditionally) that processes of absorption of heat (by one of layers 1903 and 1913) maybe separated spatially and on time from its radiation (1905) by means of the energy accumulator 1910.

FIG. 19F represents following embodiment of said membrane, the upper surface of which is covered by solar cells (or other sun receivers) 1908. Such design may be combined with FIG. 19A and comprises means (for example, LED, OLED, quant point, light panel) 1907 allowing to display necessary information for the people who are being below (for example, on Earth's surface) or to illuminate the areas of their work. The membrane FIG. 19G includes a number of video receivers 1909 to form the distributed network of reception and the analysis of images of ground-based situations that allows analyzing and more precisely recognizing different dangerous events (for example, a fire in the forest or in cities) and tracking infringers. In this case the membrane 1912 can comprise thin transparent film or a netting consisting of thin inflatable tubes (not shown) to be less appreciable from the Earth's surface. The UMAV having such membrane has to have means for analyzing and recognizing said image and means for telecommunication results to corresponding center(s).

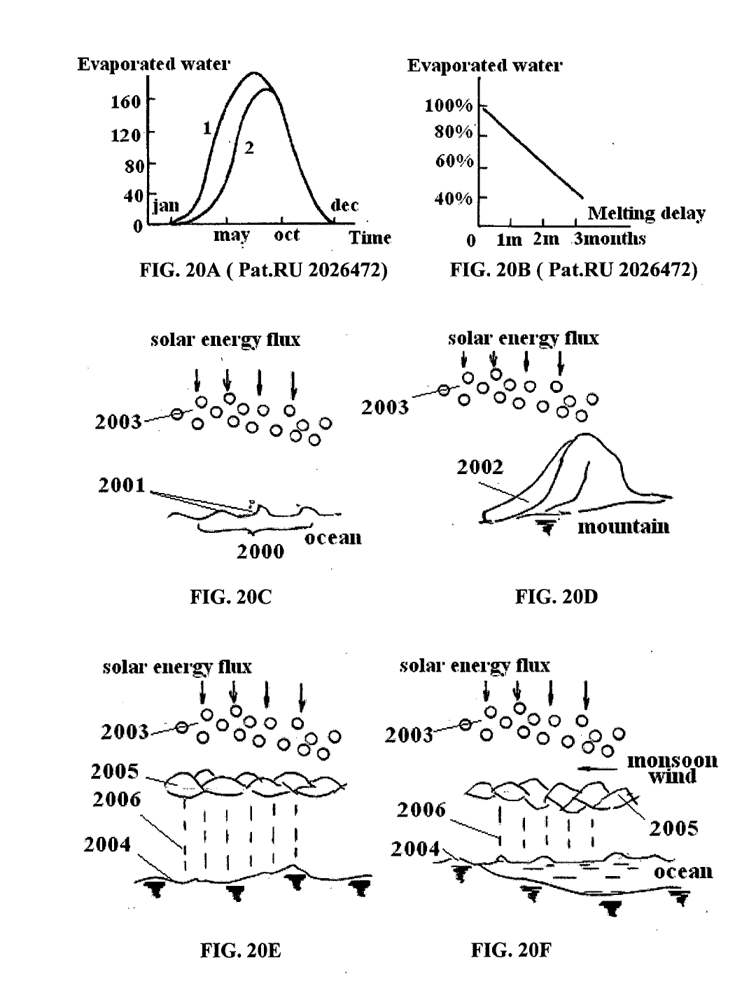

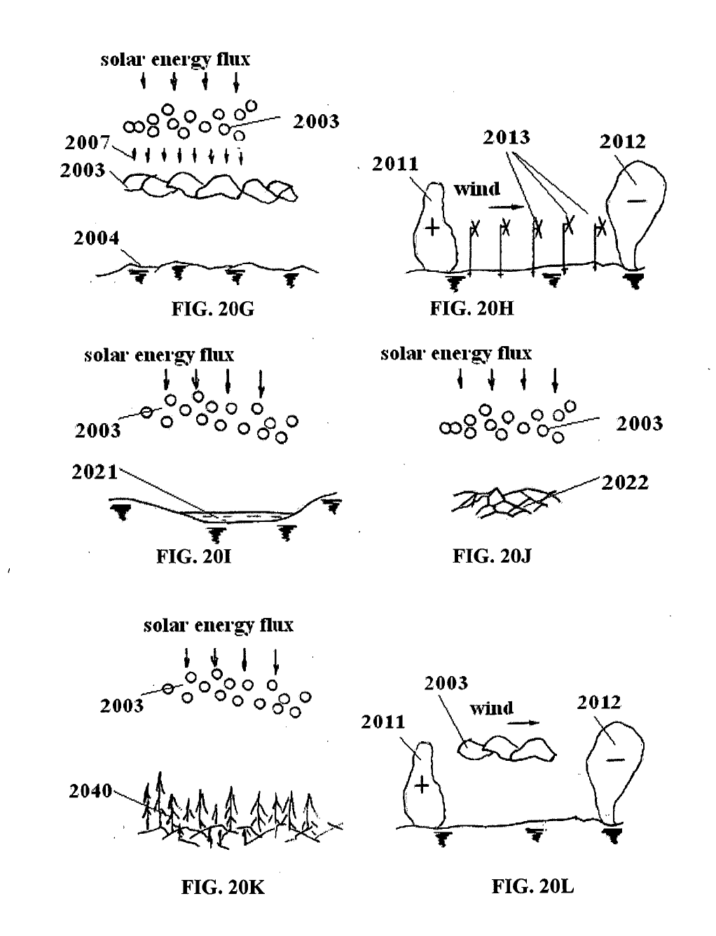

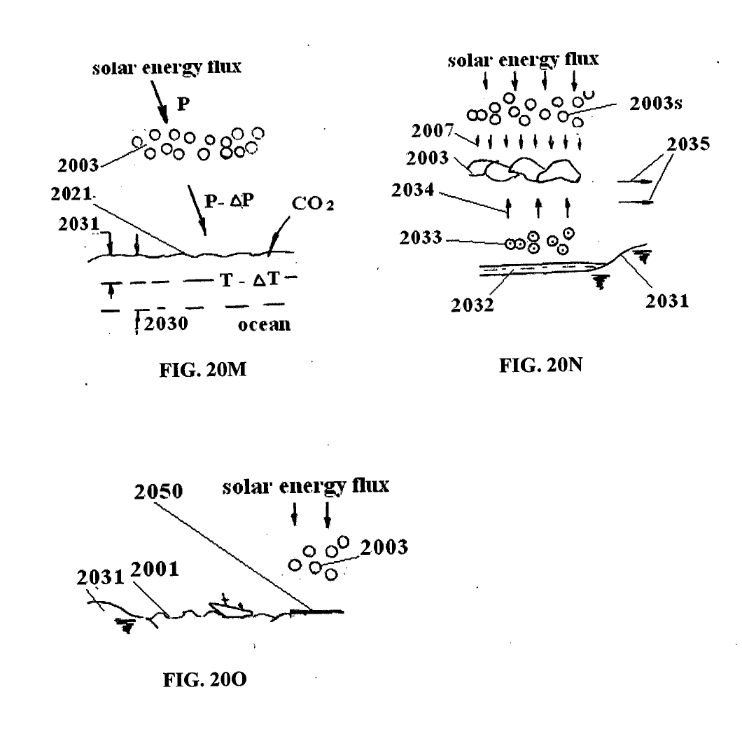

FIG. 20 illustrates different possibilities of the useful use of said sun radiation screens. Monitoring weather centers and management stations are not shown. FIGS. 20A-20B illustrate said screening effect on the example of Aral Sea. FIG. 20A shows the approximate dependence of the amount of evaporated water (1) for each month of the year (Pat. RU 2026472, Feldman). This curve is based on old data when the sea degradation rate was lower. The vertical scale is conditional. The ice melting began in April, and water evaporation increases sharply. In September the external temperature decreases, and water evaporation decrease. The curve 2 has been calculated, and it shows how said water evaporation decreases depending upon of delay of ice melting that can be achieved by increasing the thickness of the ice (by freezing), by covering ice with a protective layer, and also by means of delaying the ice melting using chemical substance or screening sun radiation. The melting delay of 1 month is capable of saving about 20% water (2) of total volume of evaporation water (FIG. 20B).

FIG. 20C shows that in case of danger that any part 2000 of ocean surface 2001 can appear overheated (temperature more 26.5° C.) the artificial cloud 2003 is capable of reducing a share of solar energy flux reaching surface of ocean and preventing from the further rise of said ocean surface temperature. FIG. 20D shows that the artificial cloud 1803 is capable of helping a preservation of the glacier 2002. FIG. 20E illustrates a possibility of rain initiation in the necessary place 2004. The artificial cloud 2003 located above rain cloud weakens a solar energy flux that cools the upper part of this rain cloud 2005, promotes ice crystals (drop condensation centers) formation, and causes a rain 2006. Simultaneous use of known means of rain initiation (iodide silver, small particles, etc.) can only strengthen this effect. FIG. 20F illustrates other frequent case when monsoons or other winds bring said rain or snow clouds 2005 causing flooding (or snow) at coast. Timely notice about moving rain cloud 2005 (for example, by means of satellites) above ocean surface allows to create the artificial cloud 2003 which can initiate earlier rain or snow 2006 over ocean decreasing total quantity of water in cloud and to weaken possible flooding. FIG. 20G represents an opposite case. The artificial cloud 2003s that is capable to strengthen solar energy flux 2007 warms the upper part of the rain cloud and promotes melting of existing ice crystals that interferes with their formation and an origin of rain in the said place. FIG. 20H shows a possibility of strengthening of wind and, accordingly, a efficiency of wind generators 2013 creating on the one hand from generators (windward side) cooled area and, correspondently, increasing atmospheric pressure 2011, and, on the other hand (leeward) heating up by means of other artificial cloud or any in another way an opposite area and reducing pressure 2012. It causes a wind strengthening. FIG. 20I shows that said artificial cloud 1803 cools a lake surface 2021 preventing water evaporation. FIG. 20J shows that said artificial cloud 2003 cools a droughty area surface 2021 preventing with water evaporation and keeping water in soil. It can be useful and for the Aral Sea in Central Asia, for the Salton Sea in southern U.S. and for Chad-lake in Central Africa. FIG. 20K shows the protection of dry forest 2040, wherein the forest fire is possible. The cloud located over any edges of the ice field allows strengthening this edge of the ice. Such artificial cloud could be flying for many years using a minimum of material (e.g. film thickness up to 5μ and the area of about 30 thousand square meters for each UMAV). Such clouds can be moved to another location desired in given time. As such “umbrellas” can be used and the clouds created from short-living frozen soap bubbles. Metallic surfaces located on the ground under said screen can increase effect of said screens.

FIG. 20L illustrates a possibility of moving clouds, changing a solar radiation flux and creating a temperature difference in adjacent areas. It is enough to change temperature only on the one part. FIG. 20M illustrates yet another opportunity, independent or accompanying one of other processes shown in FIG. 20C and FIG. 20I. The cloud 2003 reduces the amount of solar energy reaching the ocean surface 2021 causing a decrease of water temperature and, consequently, increases CO2 absorption. The average solubility increment depends on many factors, but at normal pressure it can be accepted, as 0.045 grams/liter*degree Celsius. It is known that a surface layer 2031 having thickness that is equal to some meters (we shall accept, 10 meters) is capable of cooling in a night (i.e. losing the heat that was received throughout the day). If in following day the temperature of the layer 2031 will not be restored (because of said deficiency of heat) then the layer 2030 will start to be cooled. Let us assume that said layer 1830 has 10 meters thick. We shall accept that as a result of 10% of solar deficiency within several days the temperature of a layer 2030 will fall off on 5 degrees Celsius. Then the volume that is equal to 10 cu. m (10000 liters) appropriating 1 qu. m of ocean surface will absorb 0.045*10000*5=2,25 kg CO2. 10⁹ tons of CO2 or 10¹² kg require 4.4*10¹¹ qu. m by 10% covering, and, correspondently, 4.4 millions of UMAVs, each of which comprises membrane having square that is equal to 100*100 qu. meters. This quantity is not too great if to consider necessity and that annual production of cars (much more complex) exceeding 70 million units. This storage is dynamical; an ocean current carries away water together with absorbed CO2, there this water slowly heats up and allocates gas back. Said process of absorption proceeds continuously in the meantime in a zone covered with said cloud in the meantime where coming new water is sated with CO2. FIG. 20N shows a coastal sea area 2032 and a coast 2031. In the morning the intensified solar energy flux 2007 warms coastal sea area 2032 that has not had time to cool down yet for a night. The water vapors 2033 rise upwards 2034 and are carried away to coast by morning breeze 2035 sated with a moisture. Many dangerous weather phenomena are connected with formation, transformation and movement of atmospheric fronts. Shielding of sunlight and cooling warm air masses, that are usually located above an inclined surface of said front, can assist in said front tailing and easing of intensity of dangerous phenomena. FIG. 20O shows that cooling of the edge of the ice field 2050 allows to strengthen this edge and to make easier navigation.

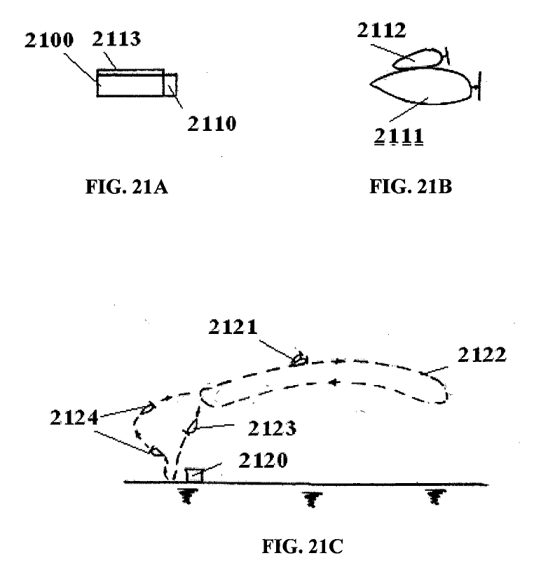

FIG. 21 shows the simplest variant of use of the energy. FIG. 21A (like FIG. 19A) represents a membrane comprising a thin flexible film 2110, a thin flexible layer 2113 and an accumulator 2110 that is built-in in UMAV-energy-transporter 2111 (FIG. 21B). Said layer 2113 includes thin flexible solar cells, the remainder place can be covered by reflecting film. FIG. 21B represents the basic fuselage 2111 of UMAV and docked to it the transport module 2112 including an accumulator of the energy that is capable of energy accumulating during to flight (UMAV 2111 has the built-in separate accumulator for current needs). UMAV 2121 (FIG. 21C) together with docked transport module makes flight on the set trajectory 2122 participating in formation of said cloud and accumulating energy in the accumulator of the module 2112. At approach UMAV to area where ground-based station 2120 (receiving energy) the transport module 2123 takes off and in the predetermined area catches up UMAV 2121. At this time the docked module 2112 undocks from UMAV and lands 2124 near the ground-based energy station 2120. The transport module 2123 having the discharged accumulator docks on its place. At station 2120 the charged accumulator of the module 2124 is changed by the new discharged accumulator. Said transport modules can be controlled by ground-base center(s). Above-said scheme of an ecologically pure solar energy transferring from flying apparatuses that fly at altitudes of many kilometers can be competitive by the proposed method of the transfer of high-altitude wind flows energy via a kilometers-long cable. This method can appear even more important if the observable tendency of wind speed reduction to be kept.

The screen located over international waters is capable of improving fishery (cooling water) without causing diplomatic problems.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

We claim:

1. A method for protecting against natural temperature-dependent dangers associated with huge mass flows, mainly: water, soil, locust, allowing carrying out this protecting at least at one of next three key stages in territorially bounded predetermined areas; said method, wherein said stages include, correspondently:
A) the first (main) stage comprises a creation of an atmospheric-based shielding “cloud” for controlling the solar radiation flux reaching Earth's surface in given area and this creation consists in launching a plurality of thin-film flying objects in the part of this flux at given altitudes including: soap bubbles and/or thin plastic flexible strips (membranes) flying approximately horizontally and covered with at least one non-transparent layer;
B) the second stage is associated with said mass forming places and comprises at least one of following processes:
b1) impeding forming of water masses at the places of large snow accumulation by the way of deceleration and/or acceleration of snow melting in places divided by time and/or place so that to lower peak intensity of melting water flows; b2) impeding forming of water masses by the way of growing tsunami hump destructing by powerful laser rays that push out water upwards and force it to loss energy when it moves and/or transits from water to air and back; b3) impeding forming of soil moving masses in the soil slopes saturated with water by the means of strengthening these slopes by long structures deepened in the ground and made from materials that are able to be expand at a tension or to have abnormal mechanical parameters; b4) protecting of green vegetation against locust by the way of initiating of transforming to gregarious form at the time periods when said green vegetation; b5) weakening of hurricane (tornado) capable of water (and wind) mass forming by the way of: i) air-dropping water pump stations that are capable of promptly starting to work when said station attaches water, and ii) creating artificial upwelling cold water area, and/or fuel-air explosive (FAE) missiles adapted for strong wind conditions;
C) the third stage is associated with places where said masses move being formed and comprises at least one following processes: c1) retention or deviation of said flood water flows using mobile elongated water-proof plastic barriers mounted in the water flows path and including means for accelerating mounting, reduction in price and made in the form of: i) two or more parallel, continuous tubular inflatable sleeves filled with water (and/or sand) and pressed to each other directly or through intermediate elements, or ii) elongated heavy wall-barrier, around or which approximately rectangular web is enveloped and so that the edges of said web are fastened in upper part of said wall forming water-tight sleeves (not necessarily closed from above);
c2) destroying of locust swarms by the way of passive traps and/or active flying means;
said method characterized in that it all said processes are intended for use in territorially bounded areas, wherein their results are necessary or wherein such processes are useful for planetary climate and cannot cause counteraction of different countries like international ocean water;
said method characterized in that it each of these stages can be used as separately, or they can be used in any combinations.

2. The method according to claim 1, wherein said creation of said shielding cloud comprises one or both following actions:
a) generating said soap bubbles by means of special generators filling said bubbles with air or light gas (mix) that is not heavier that at given height, said special generators are located on lower part of ground-based tubes extended upwards or on aircrafts (balloons) repair base or dirigibles, the necessary cold is supplied with refrigerators located on lower part of said tubes or temperature at given height for flying apparatuses;
b) launching unmanned aerial vehicles (UMAVs) that have the ability to patrol at predetermined heights (echelons) in the predetermined boundaries during prolonged periods and to tow said strips;
stretching said thin flexible plastic strips caused by an air flow pressure caused in flight an aerodynamic resistance of special elements that are located on remote ends of said strips;
changing solar radiation flux reaching Earth's surface caused by covering located on one or surface of said strips;
said method is characterized in that: i)said UMAVs comprising one or more propeller electrical engines, a group of solar cells located on their upper surface, navigation means;
ii) said solar cells are capable of supplying said engines with electrical energy directly or through intermediate accumulators (or super-capacitors), said navigation means include wind sensor, GPS, means of telecommunication with ground-based meteorological and controlling stations and can include near communication means, chosen from followings:
radar, radio, optical, and/or, sound communication to reduce a possibility of various collisions; iii) said covering are chosen from: reflecting falling flux, absorbing and transforming falling flux or radiating nano-antennas.

3. The method according to claim 1, wherein said snow melting rate control comprises one or more steps chosen from followings:
a) slowing melting with the help following actions chosen further from:
a1) weakening solar energy flow by said “cloud”,
a2) compacting snow masses by a shock wave like created jet planes,
a3) local cooling and/or freezing snow that begins to melt by dry ice or liquid nitrogen,
a4) absorbing melted water by water-absorbing material;
b) outstripping partial melting of said snow mass in a dangerous area:
b1) additional lighting said area with the help of means that can increase a duration of daylight or concentrating receive solar flux,
b2) warming said area with the help of underground heat,
b3) intensifying absorbing solar energy with help of elements of increased thermally conductivity;
said method, wherein can be used solar mirrors and/or concentrators that are based on mountains, towers, air balloons;
said method characterized in that said mirrors and concentrators are capable of turning in the wake of the sun, using correspondently drivers and sensors, taking care of the sun.

4. The method according to claim 1, comprising for weakening hurricanes (tornadoes) and disorganization of their dynamic and electrical structures following steps:
i) promptly delivery a lot of tight containers with oxygen-deficient fuel into the intensely rotating flow or into other areas of greatest sensitivity, identified as a result of practical experiments,
ii) releasing said containers,
iii) straightening out (increasing their internal volumes) with the help of elements that move apart the container envelope causing air suction through one or more openings in said envelope, necessary to achieve a predetermined explosive concentration that are defined by corresponding built-defined timers or sensors of concentration placed inside said containers,
iv) blasting said mix located inside said containers by built-in detonators connected to said timers or sensors;
said method is characterized in that said containers have thin easily expandable and easily breakable envelopes, and a size of these containers and elasticity of said elements are chosen so that for the time required to create the explosive concentration these containers would not be able to leave a predetermined area of said rotating flow;
said method is characterized in that said rapid delivery of these containers carried by ground-based or air-based missiles.

5. The method according to claim 1, comprising for impeding the saturation of hurricane (tornado) by oil vapors of emergency oil well and the fire danger one or both of the following ways:
killing (plugging) said well by the way of intensification of methane hydrates forming inside the borehole at a predetermined deep by the well-cooled solid or liquefied carbon dioxide with the help cooling said well by dry ice or liquid CO2 or nitrogen,
abandon said well via its compression shifting surrounding soil layers by electro shock waves caused electrohydraulic generators (EHG) buried around this oil well;
said method, wherein in the case of insufficient result these actions can be performed repeatedly, either independently or by turns.

6. The method according to claim 1, comprising weakening of surge or tsunami wave by the means pushing out water hump upwards from water surface to air forcing said wave to lose at least a part of its energy by passing from one medium to other and back, said method comprising:
A) before appearance of danger:
a1) definition of a bottom structure along possible path of surge or tsunami wave,
a2) calculating the most successful modes of forcing actions and lasers placement,
a3) establishing the communication of said lasers to the existing tsunami or surge wave sensors;
B) after receiving the signal of the motion a dangerous wave:
b1) estimating expected wave parameters and specifying said scenario of lasers control,
b2) forming one or more powerful laser pulses in the direction of increasing surge (tsunami) humps at predicted points of time and pushing out water hump upwards;
said method, comprising increasing of water turbidity using underwater explosions, raising sand and air bubbles from the bottom at the instant when said hump grows;
said method, comprising synchronizing in the case of simultaneous using underwater electrohydraulic generators.

7. The method according to claim 1, comprising for protecting soil against landslides and mudflows and keeping barriers:
drilling a plurality of thin wells in the dangerous slope in dry season,
inserting following means into said wells, said means chosen from group:
capsules having several openings and filled with substance that is capable easily of absorbing soil water and to expand excessively,
non-Newtonian mix that is capable of becoming firmer under external force actions,
threads made from material having negative Pascal's coefficient and that is capable of being widened at lengthening;
said method, comprising preliminary placing strong threads inside said substances and mixes, and the top ends of these threads can be used for fastening other means;
said method, wherein drilling said wells is characterized in that at least a part of said wells can have inclination and intersect at depth.

8. The method according to claim 1, for accelerating mounting of said mobile barrier including two or more water-proof tubular continuous sleeves, comprising preliminary step: a) placing said empty sleeves in predetermined order inside a common thin elongated flexible stocking made in the form of an uniform netting or a set of separate netlike sections, or tape rings, and having cross-section perimeter that is just less than the non-concave perimeter of said barrier when all these sleeves are filled completely, and following steps: b) transporting these sleeves to the dam installation place and laying these sleeves along the predetermined line of said barrier, c) filling said sleeves with water and/or sand(clay), beginning starting with the sleeves from below;
said method is characterized in that: 1) in the case if ballast-free barrier includes two sleeves then this method comprises after step (b) and before step (c) an additional step (i):
placing a number of plate (continuous or lattice) made from inflexible material between said sleeves along said barrier;
said method is characterized in that: 2) in the case if ballast-oriented barrier includes two sleeves then said method comprises after step (b) and before step (c) an additional step (ii) loading said ballast between said sleeves;
said method is characterized in that: 3) in the case if ballast-free barrier includes Cₖ₊₁² sleeves, where: k=2, 3 . . . , then said sleeves are stacked by triangle and said method comprises before step a) one of two additional steps (iii):
(iii-1) connecting a set of several points of said stocking so that each of said sleeves has appeared fixed inside of netlike cells like “honeycomb”, or
(iii-2) dividing said sleeves into groups, each of which includes 3 sleeve, and each of these groups is placed inside several separate non crossed pieces of netlike stockings, or tape rings;
said method is characterized in that further: said tape and netlike segments are dispersed (disposed) along the full length of sleeves, the height of said plates for ballast-free barrier is that that an upper edge of said plates located between said sleeves does not exceed height of sleeves and the distance between identical edges (right or left) can be chosen to be equal, and the stocking for ballast-oriented barrier should have windows (cell) in its upper part the size of which does not disturb to ballast loading;
said method is characterized in that it allows to change barrier height in certain limits, compensating roughnesses of ground surface, by pulling up of said tapes or netlike loops that reduces local perimeter of this stocking and approaches its cross-section to a circle.

9. The method according to claim 1, using mobile elongated water-proof plastic barriers for retention or deviation of flood water flows, comprising:
i) preliminary creating a number of warehouses, wherein a set of preliminary prepared said water-proof plastic flexible webs and a plurality of blocks for mounting said walls are stored,
and after receiving a message about expected flood:
ii) defining a line of protective barrier location,
iii) analyzing a surface along said line by map or at side of said location and evaluating whether the roughness of surface along said line makes leveling desirable; and when additional resource is desirable, levelling at least a part of said surface,
iv) delivery necessary amount of said webs and said blocks;
iv) laying one or more said water-proof flexible web on the ground along said line, and if necessary then two or more said webs are water-proof connected to each other in series increasing common length of said barrier,
v) mounting said wall from said delivered blocks along the middle of said web approximately, and this mounting includes stacking said one or more blocks in the form of vertical sections, said blocks are fastened to each other, said sections are places in row along said middle of web, and said adjacent sections are fastened to each other forming an united barrier wall;
said method, wherein the height of said wall and its width are chosen sufficient to resist expected flood (its water level and water force);
said method, comprising further:
vi) increasing the width of said web using fastening additional pieces of web material if necessary,
vii) lifting of both edges of said web located on both side of said wall, correspondently, of rear and front (on the flood side) edges and their fastening so that said front edge would be located not below an expected flood level;
said method is characterized in that in the case if said section includes more one block then the block that is located above is not heavier than located lower;
said method characterized in fact that for effective protection against floods is useful to standardize the block sizes, weights and how they are docking, that allow to manufacture pre-stock units, store them and use them in a dangerous period.

10. The method according to claim 9, wherein different plastic capacities (mainly, already had been used earlier: bottles, canisters, boxes, bags etc.) are used for creating said blocks by the means:
i) preliminary filling said capacities with sand and corking said capacities tightly, and further by one of three nest ways:
ii) filling continuous or latticed containers like cubic containers with said elements and other heavy ballast: stones, old asphalt or concrete bits, metal details and like, and so that said containers would be more closely filled;
iii) placing for creating of each block a group of said corked bottles, corked tube or corked canisters and pressing to each other so that to form a parallelepiped-like block and wrapping this block with multi layers of adhesive film on turntable;
iv) placing for creating of each block a row of said bottles or tube having alternating diameters so that to form a wedge-shape block;
said method, wherein said blocks can be fastened to each other by built-in fastened means or external rods or tubes.

11. The method according to claim 9, wherein for accelerating of said barrier mounting, said method comprises:
i) fastening an elongated tubular balloon, a row of automatic catches and a row of corresponding receivers for said catches fastened to front side of said wall on corresponding height, and their parameters are chosen so that when flood water level lifts, this water would lift and said balloon together with said frond edge and catches, press these this web and these catches to front side of said wall, and when these catches will reach predetermined level these catches will
catch said receivers; and further: ii) can comprise additionally a similar system on the back for the automatic lifting and fastening said rear edge, but only the lifting is realized due to pumping said balloon with separate pump and expansion of special protrusions that repel said balloon from the ground;
said method, wherein for filling said front balloon can be used built-in cylinders filled with compressed gas or air.

12. The method according to claim 10, wherein for preventing infiltration of water between said barrier and rough ground are located dumbbell-shaped (or drop-shaped) balloons chambers having high-elastic easily expandable balloons and low expandable narrow connecting tubes, said chambers are located in those places where because of rough ground between adjacent sections the empty angular cracks are formed;
said method is characterized in that the lengths of said connecting tubes are equal to the width of barriers;
said method is characterized in that said chambers can be mounted i) before said web laying placing directly said chambers or ii) after mounted said sections by means of long rod or said connecting tubes can be rigid tubes;
said method further comprising: i) connecting rear balloons through branch tubes to one or more water (or air) pumps, ii) filling said balloons with water (or air) so that at least front chambers would cover said cracks;
said front balloons can be connected in general roller or a set of group rollers.

13. Blocks and a barrier using these blocks for protection against flood, wherein:
said blocks can belong to one or more of following main types:
i) containers like “cubic” container or crates that are connected to each other using known means of trade industry and can be connected by means of corresponding means;
ii) preassembled groups of elements pressed to each other, and such block are wound thin film round (further: wrapped blocks); said stacked “wrapped blocks” are located between four corner pillars and said four corner pillars together with said wrapped blocks are wound tightly by thin flexible adhesive tape around, and so that it was the possible to connect said adjacent sections among themselves tightening adjacent corner pillars by clamps;
iii) wedge-shaped (triangle prism) blocks; in this case said sections consist of stacked wedge-shaped blocks, each such section is mounted so that all acute edges of these wedge-shape blocks are directed to coming flood, and so that the bulges on adjacent sides of one block would be coincided with hollow of second as much as possible; and said wedge-shaped blocks having their envelopes can be made in one of two following forms:
1) in the form of a water-proof mattress filled with sand, clay and/or water, the shape of which is supported by internal connecting cables having corresponding length and connecting two sides forming said wedge, or
2) in the form of water-proof envelope, in which a number of cylindrical elements (bottles and/or tubes) placed as possible as in the order of increasing diameters, the rest space inside this envelope between said elements is filled with sand, and the wedge shape of said block is supported by external wrapping thin film tapes;
said barrier, wherein each said blocks are filled with elements as possible snugly, and said elements are chosen from followings: a) elements filled with sand, clay or water: 1) corked canisters, 2) corked bottles, 3) closed boxes, 4) welded plastic bags, 5) corked pipes, and also: 6) stones, 7) old asphalt or concrete bits, 8) metal units, and like;
said blocks are capable of filling a space between two parallel, spaced apart, sleeves connecting with web and/or to be connected in sections for the subsequent integrating these sections in said elongated wall, wherein said sections consists of one or more blocks located one on top of the other, stacked up and fastened to each other so that its height exceeds the expected flood level and compensates the ground roughness;
said bather, wherein for connection of said blocks can be used also clips, elastic cords with hooks (for the hinges of eyelets), Velcro, high adhesive coating or their combinations.

14. The blocks and the bather according to claim 13, wherein said bather comprises:
said elongated wall consisting of a plurality of said sections composed from said blocks and installed in a row along said web about in the middle of it, and so that adjacent sections are placed closely and fastened to each other by clamps, clips and/or connecting means;
an elongated water-tight flexible web having approximately rectangular shape located across predicted flood flow path,
said bather, wherein said flood, taking into account an web is wrapped around said wall from below so that the edge of rear part (with respect to the flooding) of said web and the edge of front part of said web were fixed by mechanical connection or welding (or gluing), and at least said front edge is located not lower than predicted flood level;
said barrier, wherein said wall has not necessarily constant cross-section barrier on length, and this cross-section can be have one of following forms: rectangular, triangular, or their combination;
said barrier characterized in that said wall has a height above predicted flood level and width of this wall is sufficient to counteract the predicted additional fastening means and the weight of said sections;
said barrier, wherein the middle part of this long web can be covered from below with hydrophobic material or material having a high adhesion relatively to ground;
said barrier, wherein a compensation of ground roughness and, correspondently, different heights of separate sections require corresponding width of said web, and this width can be ensured using: i) surplus web width, ii) widening with additional strips having self-adhesive covering together with mechanical clips, iii) attaching additional strips by means of water-proof zipper that includes a plurality of teeth fixed on said edge of said web and one or more sliders (for manual or with the help of built-in engine together with an energy source and an air compressor for dirt removal);
said barrier is characterized in that the standardization of sizes of said sections and said blocks is desirable;
said barrier may include means allowing to be anchored in the ground.

15. The method in according to claim 1, wherein for detecting the point in time at which said locust begins to transfer from Solitarious (single) phase into Gregarious phase are used a plurality of mini-devices placed over surface of dangerous areas, each of said mini-devices comprises one or more embedded sensors, allowing to detect said point, and said sensors carry out at least one or more following analysis:
acoustical sensors as analyzers of squeak that said locust generates in result of friction its hips of the hind legs on each other,
chemical sensors as analyzer of the pheromone that the locust male skin excretes; said method characterized in that it can comprise the additional use optical and/or acoustical sensors mounted on unmanned flying objects (planes or dirigibles);
said method characterized in that said sensors are connected in common network by wireless, acoustical, and/or optical communication means, allowing to transmit information about Gregarious locust to said control centers, directly or with the help of neighboring sensors, forming a network;
said system, characterized in that it may comprise said means in various combinations.

16. The method according to claim 15, comprising the initiation of an earlier locust development (the awakening), or the later locust development, so that this initiation is produced:
in more earlier (cold) or more later period, when the largely absent various green vegetation,
in different areas in turn, promoting theirs destroying in the allowed time;
said method is characterized in that the process of initiation includes thermal effects on separate areas in which the larvae or individuals are dormant,
said method is characterized in that said process of initiation may include additionally one or more type effects, promoting transforming from Solitarious (single) phase into Gregarious phase, chosen from the followings:
an initiation of creaking sound of rubbing thighs hind legs of locusts,
an visual initiation in the form of many small transparent container with a small holes, and filled with locusts that are in the gregarious phase,
a chemical initiation using spray pheromone,
a light initiation;
said method is characterized in that in areas that are closely to said areas of initiating a set of passive traps in the tube-like form prolonged upwards and having the transparent walls, an lower internal part of which is painted green color, and means for a lulling to slip and/or destruction of a locust are placed in this bottom part of each of said tubes.

17. The method according to claim 15, wherein for destructing flying a locust swarm by explosions of FAE (fuel-air explosive) delivered by airplanes and/or gliders, then blow up around said swarm, and said FAE is delivered in both following ways:
spraying a plurality of FAE clots around said locust swarm with a “cloud” formation and subsequent blasting said “cloud” by external detonating,
dropping a plurality of extendable containers having buoyancy close to neutral and filled with FAE and subsequent blasting said containers by external or internal automatic detonating;
said method, comprising for initiation of said clots and containers explosion following means, chosen from followings: bullets-detonators, chemical detonators and UV laser rays, ejectors of which are located on said or additional flying vehicles, and that are capable to detonate said clots within a predetermined time period after spraying;
said method characterized in that each of said extendable containers:
includes two or more chambers, first of said chambers is use as FAE storage, other (main) chamber having a flexible easily extensible envelope is intended for formation of a mix capable to blow up, and resilient means,
being in the folded position aboard of said airplanes and/or gliders comprises the empty main chamber, the first chamber is filled with said FAE, and said compressed resilient means;
said method comprising following steps that are carrying out automatically after dropping said containers:
releasing said resilient means, said resilient means straightening
expanding the main chamber envelope that results
pressing out said FAE from said first chamber into said main chamber and in same time drawing in atmospheric air (or special gas) through said openings into said main chamber,
after filling said main chamber said detonating means blow up said mix which breaks off at once the main chamber envelope so that the fiery cloud extends and destroys the nearest part of flight of a locust;
said container can have the average density that is little more or less than air depending on the location of corresponding “cloud”;
said method characterized in that predetermined sizes of said openings, their relations and change of internal pressure of said cylinder allows to hold necessary time period and to use automatic built-in detonator;
said method characterized in that it is preferably that a modulo of buoyancy (concerning air) is not more than an average buoyancy of an environment where swarm move;
said method characterized in that in case of positive buoyancy said containers can be started from earth's surface or other flying means.

18. A system for controlling solar radiation flux reaching predetermined area of Earth's surface, comprising:
i) a plurality of unmanned aerial vehicles (UMAVs) that have the ability to patrol at predetermined heights (echelons) in the predetermined boundaries during prolonged periods and are capable of controlling a solar radiation flux that reaches Earth's surface, ii) one or more management stations collecting meteorological information, information about aircraft routes and migration of birds, analyzing these data and directing to said UMAVs messages about required areas of their flights, altitudes and meteorological conditions in said areas by means of telecommunication means;
said system, wherein said UMAVs are made on the base of one of following types chosen from: fixed-wing aircrafts, aircrafts using inflatable elements, double-fuselages dirigibles, dirigible-hybrids, or like;
said system, wherein said UMAVs comprise one or more electric propeller engines and a group of solar cells located on upper surface of said UMAVs, and said solar cells are capable of energy supplying these electrical engines directly or with the help of intermediate accumulators (or super capacitors);
said system, wherein each of said UMAVs comprises a wide membrane that is capable changing the passing solar energy flux by means of covering that is located on one or both surfaces of this membrane;
said system, wherein said membrane consists of one or more separate thin flexible plastic strips fastened from below to said UMAV wings so that these strips are located close to each other or adjacent strips can somewhat overlap one another in the form of approximately horizontal plane-shape sheet, and said strips include aerodynamic elements that are located on remote ends of said strips and try to stretch these strips in flight using a pressure of air flow;
said system, wherein each of said UMAVs includes GPS and telecommunication means, and at least a part of said UMAVs can comprise a wind sensor, means for communication with other (nearest) UMAVs, chosen from followings: radio, optical, and/or, sound communication to reduce a possibility of various collisions;
said system, wherein said UMAVs can include additional means that is fastened from below to said UMAVs wings and is capable unrolling (unfolding) and rolling (folding) said strips (membranes) depending on conditions of flight.

19. The system according to claim 18, wherein a plurality of said UMAVs patrolling in limited area at predetermined heights are characterized in that upper surfaces of their membranes are covered with reflecting thin layer that reduces the solar radiation energy flux reaching given area of Earth's surface, and wherein a plurality of said flying UMAVs being configured in form of cloud:
i) above drying up lakes to decrease evaporation and to keep water lake level,
ii) above snow mass to delay snow melting and to reduce melting water flow intensity,
iii) above overheated dangerous areas of ocean surface to lower water surface temperature and to complicate progress of hurricanes,
iv) above predetermined areas of ocean surface to lower temperature of this surface and to increase CO2 absorption by ocean surface layer,
v) above upper surface of rain (or snow) saturated cloud to lower temperature of this cloud and to cause earlier precipitation (rain or snow) in more safe area,
vi) above droughty areas to lower temperature of soil and to reduce evaporation,
vii) above dried-up forest to lower temperature of trees and to weaken fire danger,
viii) above an atmospheric front to lower temperature of warm air near this front and to weaken an intensity of air flows;
said system, wherein said precipitation initiating can be combine with air-dropping dry ice, iodide silver and like.

20. The system according to claim 18, wherein a plurality of said UMAVs patrolling in limited area at predetermined heights above the ozone layer maximum are characterized in that upper surfaces of their membranes are covered with wideband solar to electrical energy convertors, and said convertors are connected to the high-frequency (HF) generators, outputs of which are connected to nano-antennas that are located on bottom surface and directed to predetermined area of Earth's surface, and said generators and nano-antennas are tuned to the frequency that is corresponded to one of zones of transparency for atmospheric gases that increases the solar radiation energy flux reaching given area of Earth's surface, and wherein a plurality of said flying UMAVs being configured in form of cloud: i) above snow mass to accelerate snow melding and to reduce melting water flow intensity, ii) above coastal sea areas to rise morning temperature and to create of water vapors clouds that can be carried from sea to coast with morning breeze for drought reducing, iii) above important vegetation to rescue this vegetation against cooling, iv) above upper surface of rain (or snow) saturated cloud to fall temperature of this cloud and to delay or to weaken precipitation (rain or snow) in such place where cities and important vegetation area.

21. The system according to claim 18, wherein a plurality of said UMAVs patrolling within predetermined area at predetermined heights near Earth's surface are characterized in that for protecting against cooling vegetation and to keep ascending air flows said membranes are chosen from following types: i) transparent for day solar radiation and/or ii) reflecting warm radiation of Earth's surface at night.

22. The system according to claim 18, comprising a set of auxiliary UMAVs that can also patrol within given area at predetermined heights near Earth's surface, and wherein said flying UMAVs being configured in form of cloud:
i) above places of accidents and/or crowd to illuminate and to display with the help of a number of lighting and display devices mounted on the membranes and receiving additional energy from solar cells located on said membranes and/or additional accumulators for providing round-the-clock work, and/or
ii) above places where arsons, hotbeds of fire and other dangerous events to carry out a surveillance and to detect situations using video cameras, distributed across the surface of the membrane that allows extending the information base for the analysis and recognition of these events.

23. The system according to claim 18, wherein at least a part of said UMAVs (further:
main UMAVs) include a set (or a layer) of additional thin flexible solar cells located on the upper surface and connected to an additional block of accumulators (or super capacitors) that is intended to energy accumulation during flight;
said system comprising one or more ground-based stations that are intended for receiving and storing said energy and supplying with this energy of ground-based consumers;
said system comprising additionally one or more UMAV-energy-transporters that are intended to transporting said energy from said main UMAVs to said ground-based stations in the form of said blocks; and that are capable of docking to said main UMAVs carrying discharged blocks, exchanging their discharged blocks for charged blocks of main UMAVs, undocking from main UMAVs, transporting said charged blocks to said ground-based stations, exchanging said charged blocks for discharged blocks and transporting said discharged blocks in the opposite direction;
said system, wherein said UMAV-energy-transporters and said main UMAVs can be implemented in one of two following embodiments: i) said blocks are made as relocatable, and said exchanging consists in said exchange of said blocks between said main UMAVs and said UMAV-energy-transporters; ii) said exchange blocks are fastened to corresponding UMAV-energy-transporters, said UMAV-energy-transporters are docked to corresponding main UMAVs permanently during to flight, and said exchange consists in that near said station UMAV-energy-transporter having charged block undocks from its UMAVs and moves to said station, and at the same time another UMAV-energy-transporter carrying uncharged block docks to main UMAV into free position;
said system, wherein the exchange said UMAV-energy-transporters or said blocks is possible between different main UMAVs that flies at different heights.
